(19) United States
(12) Patent Application Publication
(10) Pub. No.: US 2017/0351142 A1
(43) Pub. Date: Dec. 7, 2017

(54) LIQUID CRYSTAL DISPLAY DEVICE

(71) Applicant: Sharp Kabushiki Kaisha, Sakai City, Osaka (JP)

(72) Inventors: TAKAO IMAOKU, Sakai City (JP); YOSHINOBU HIRAYAMA, Sakai City (JP); SHUGO YAGI, Yonago-shi (JP)

(21) Appl. No.: 15/538,608

(22) PCT Filed: Dec. 17, 2015
(86) PCT No.: PCT/JP2015/085313

§ 371 Date: Jun. 21, 2017

(30) Foreign Application Priority Data
Dec. 24, 2014 (JP) 2014-260241

(51) Int. Cl. G02F 1/1335; G02B 5/30; F21V 8/00

(52) U.S. Cl. CPC G02F 1/133603; G02F 1/13362; G02B 6/0086; G02B 5/3083; G02B 6/0031; G02B 6/0056

(57) ABSTRACT

A liquid crystal display device includes a light source, a light guide plate, a backlight unit, and a complex polarizing plate. The light guide plate includes light collecting portions to collect light rays exiting through a light exiting surface with respect to a direction perpendicular to an optical axis of the light source to direct the light rays in a frontward direction. The backlight unit includes an optical sheet to collect the light rays to direct the light rays in the frontward direction. The complex polarizing plate includes a selective reflecting sheet and a polarizing plate. The selective reflecting sheet includes a first transmission axis and a reflection axis perpendicular to the first transmission axis. The polarizing plate includes a second transmission axis. The complex polarizing plate is laid on the backlight unit with the first transmission axis and the second transmission axis perpendicular to the light collecting direction.

### TECHNICAL FIELD

The present invention relates to a liquid crystal display device.

### BACKGROUND ART

Display devices including liquid crystal display panels as display components for displaying images (e.g., smartphones, tablet computers, television sets, digital cameras, and car navigation systems) have been known. Because the liquid crystal panels do not emit light, the liquid crystal panels are provides with lighting devices that apply light from the back of the liquid crystal panels (known as backlight devices). A lighting device including a light guide plate and light emitting diodes (LEDs) opposed to an end surface of the light guide plate has been known. Such a light device is referred to as an edge-light lighting device (or a side-light lighting device). This type of lighting device is suitable to reduce a thickness and power consumption.

In the edge-light lighting device, the end surface of the light guide plate is a light entering surface through which light from the light source enters and a plate surface of the light guide plate on the front side is a light exiting surface through which the light that has entered through the light entering surface exit toward the liquid crystal display panel. The light that has entered the light guide plate through the light entering surface travels through the light guide plate while repeating reflection and exit through the light exiting surface.

The lighting device includes an optical sheet that covers the light exiting surface. The optical sheet includes layers of a diffusing sheet, a prism sheet, and the like. The light exiting through the light exiting surface is transmitted through the optical sheet and converted into planar light. The planar light is supplied to the liquid crystal display panel.

As disclosed by Patent Document 1, a lighting device that includes a single prism sheet and a light guide plate that includes a light collecting portion has been known. The lighting device includes the single prism sheet that replaces a multilayered optical sheet to reduce the thickness. The light collecting portion includes prism sheets and cylindrical lenses on a light exiting surface or a surface opposite from the light exiting surface. The light collecting portion of the light guide plate includes multiple longitudinal prisms arranged in line on a front side or a rear side of the light guide plate with the longitudinal direction aligned with an optical axis of light from the light source. The prism sheet also includes multiple prisms arranged parallel to the light collecting portion of the light guide plate.

In such a lighting device, the light exiting from the light guide plate is collected due to optical effect of the light collecting portion and directed to the prism sheet. Furthermore, the light directed to the prism sheet is collected in the frontward direction according to the optical properties of the prisms. As a result, the light is converted into even planar light. The light collecting property of the light collecting portion of the light guide plate and the light collecting property of the prisms of the prism sheet are observed in arrangement directions of the light collecting portion and the prisms.

### RELATED ART DOCUMENT

### Patent Document

Patent Document 1: International Publication No. 2012/050121

### Problem to be Solved by the Invention

In a liquid crystal display device including the lighting device having the light collecting property described above, light is emitted along a frontward direction relative to a display surface of a liquid crystal display panel (a direction normal to the display surface). The display surface may include areas through which the larger number of light rays exit and travel in direction angled to the frontward direction toward the display surface (i.e., in directions with small angles relative to the display surface), which form side lobe light, resulting in reduction in frontward brightness or uneven brightness.

### DISCLOSURE OF THE PRESENT INVENTION

The present invention was made in view of the foregoing circumstances. An object is to provide a liquid crystal display device in which a reduction in frontward direction and uneven brightness are less likely to occur.

### Means for Solving the Problem

A liquid crystal display device according to the present invention includes a light source, a light guide plate, a backlight unit, and a complex polarizing plate. The light guide plate is a plate shaped member that includes a light entering surface, a light exiting surface, and a light collecting portion. The light entering surface is an end surface of the plate shaped member and opposed to the light source. The light exiting surface is a front plate surface of the plate shaped member through which light entering through the light entering surface exits. The light collecting portion is formed in the light exiting surface and/or a rear plate surface of the plate shaped member. The light collecting portion is configured to collect light rays exiting from the light exiting surface with respect to a light collecting direction perpendicular to an optical axis of the light source to direct the light rays in a frontward direction. The backlight unit includes an optical sheet disposed to cover the light exiting surface and collecting the light rays exiting through the light exiting surface with respect to the light collecting direction to direct the light rays in the frontward direction while transmitting the light rays therethrough. The complex polarizing plate includes a selective reflection sheet and a polarizing plate. The selective reflection sheet includes a first transmission axis for passing linearly polarized light in a first condition along the first transmission axis and a reflection axis perpendicular to the first transmission axis for reflecting linearly polarized light in a second condition along the reflection axis. The polarizing plate includes a second transmission axis for passing the linearly polarized light in the first condition. The polarizing plate is laid on the selective reflection sheet with the second transmission axis parallel to the first transmission axis. The complex polarizing plate is laid on the backlight unit with the first transmission axis and the second transmission axis along a non-light collecting direction perpendicular to the light collecting direction.

Because the liquid crystal display device has the configuration described above, the selective reflection sheet of the complex polarizing plate actively reflects the light rays of the light exiting from the backlight unit which travel in directions angled to the frontward direction toward sides in the light collecting direction (side lobe light). The reflected light rays are multiply scattered and thus the polarization is canceled. The reflected light rays form a light flux that contributes to improvement of the brightness in the frontward direction. Therefore, the reduction in forward brightness or the uneven brightness is less likely to occur in the liquid crystal display device.

In the liquid crystal display device, the optical sheet may include a sheet base having a sheet shape and a prism sheet that includes a prism portion formed on a front surface of the sheet base opposed to the complex polarizing plate. The prism portion may include a plurality of unit prisms having elongated shapes that extend in the non-light collecting direction. The unit prisms may be arranged along the non-light collecting direction.

In the liquid crystal display device, each of the unit prisms may have a triangular cross section with a vertex having an angle of 90°.

In the liquid crystal display device, the sheet base may be made of material that does not have a birefringent property.

In the liquid crystal display device, the light collecting portion may include a plurality of unit light collecting portions having elongated shapes that extend along the non-light collecting direction and being arranged along the light collecting direction.

In the liquid crystal display device, each of the unit light collecting portions may have a triangular cross section with a vertex having an obtuse angle or a semicircular cross section.

In the liquid crystal display device, the light source may include a plurality of point light sources arranged in line along the light collecting direction.

In the liquid crystal display device, the backlight unit may include the light guide plate that is the plate shaped member disposed in a flipped position.

The liquid crystal display device may further include a light exiting-side polarizing plate opposed to the complex polarizing plate and a liquid crystal display panel disposed between the complex polarizing plate and the light exiting-side polarizing plate.

### Advantageous Effect of the Invention

According to the present invention, a liquid crystal display device in which a decrease in frontward brightness and uneven brightness are less likely to occur is provided.

### BRIEF DESCRIPTION OF THE DRAWINGS

FIG. 1 is an exploded perspective view illustrating a schematic configuration of a liquid crystal display device according to a first embodiment of the present invention.

FIG. 2 is an exploded perspective view illustrating a schematic configuration of a backlight unit in the liquid crystal device.

FIG. 3 is a cross-sectional view of the liquid crystal display device along a longitudinal direction thereof (an X-axis direction) illustrating a cross-sectional configuration.

FIG. 4 is a cross-sectional view of the liquid crystal display device along a transverse direction thereof (a Y-axis direction) illustrating a cross-sectional configuration.

FIG. 5 is a plan view of a light guide plate.

FIG. 6 is a back view of the light guide plate.

FIG. 7 is a cross-sectional view of the backlight unit along a transverse direction thereof (the Y-axis direction) illustrating a cross-section configuration.

FIG. 8 is a cross-sectional view along line A-A in FIG. 7.

FIG. 9 is a perspective view schematically illustrating a complex polarizing plate.

FIG. 10 is an exploded perspective view schematically illustrating a positional relationship between a backlight unit and a complex polarizing plate in a testing device.

FIG. 11 is a graph illustrating a relationship between angle of a transmission axis of the complex polarizing plate and relative value of a frontward brightness in the testing device.

FIG. 12 is a perspective view schematically illustrating a relationship between the testing device and a coordinate system.

FIG. 13 is a diagram illustrating measured brightness distribution (light distribution characteristics) of light exiting from the testing device with a transmission axis of the complex polarizing plate at 90°.

FIG. 14 is a diagram illustrating measured brightness distribution (light distribution characteristics) of light exiting from the testing device with the transmission axis of the complex polarizing plate at 0°.

FIG. 15 is a perspective view schematically illustrating a relationship between the testing device and another coordinate system.

FIG. 16 is a diagram illustrating measured brightness distribution (light distribution characteristics) in a “12 o'clock-to-6 o'clock” direction in the testing device.

FIG. 17 is a diagram illustrating measured brightness distribution (light distribution characteristics) in a “3 o'clock-to-9 o'clock” direction in the testing device.

FIG. 18 is a graph illustrating a relationship between the brightness ratios of frontward light relative to side lobe light in the 3 o'clock-to-9 o'clock” direction in the testing device and angles of the transmission axis of the complex polarizing plate.

FIG. 19 is an exploded perspective view schematically illustrating a positional relationship between a backlight unit and a complex polarizing plate in a testing device in a liquid crystal display device according to a second embodiment of the present invention.

FIG. 20 is an exploded perspective view schematically illustrating a positional relationship between a backlight unit and a complex polarizing plate in a testing device in a liquid crystal display device according to a third embodiment of the present invention.

FIG. 21 is a graph illustrating a relationship between angle of a transmission axis of a complex polarizing plate and relative value of a frontward brightness in a testing device according to a comparative example.

FIG. 22 is a graph illustrating a relationship between angle of a transmission axis of a complex polarizing plate and relative value of a frontward brightness in a testing device according to another comparative example.

### MODE FOR CARRYING OUT THE INVENTION

### First Embodiment

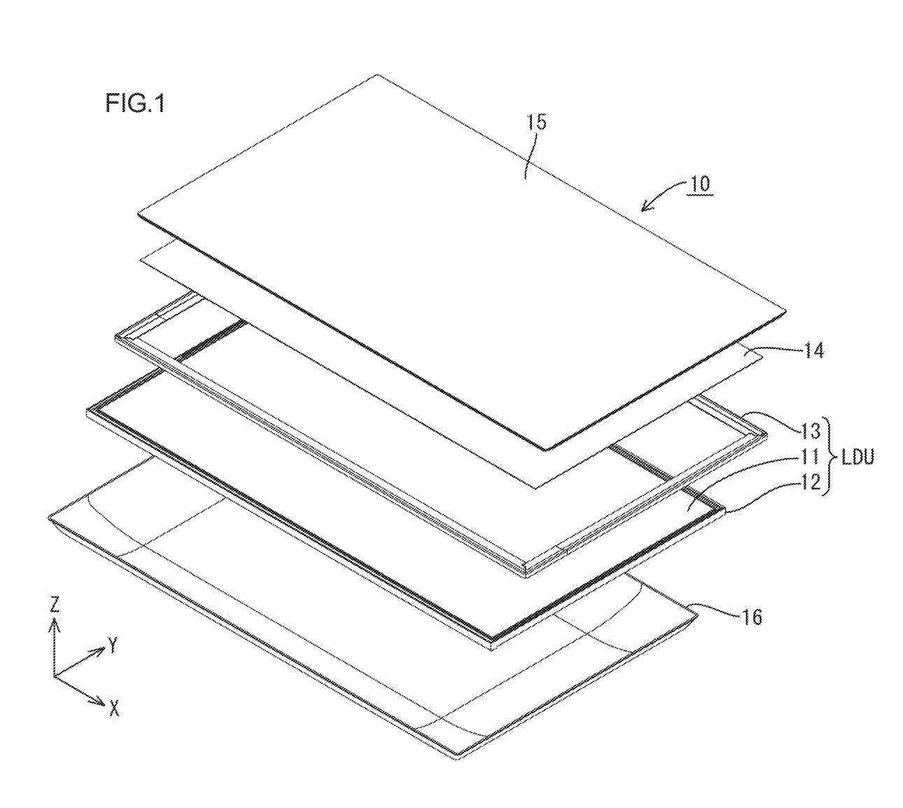

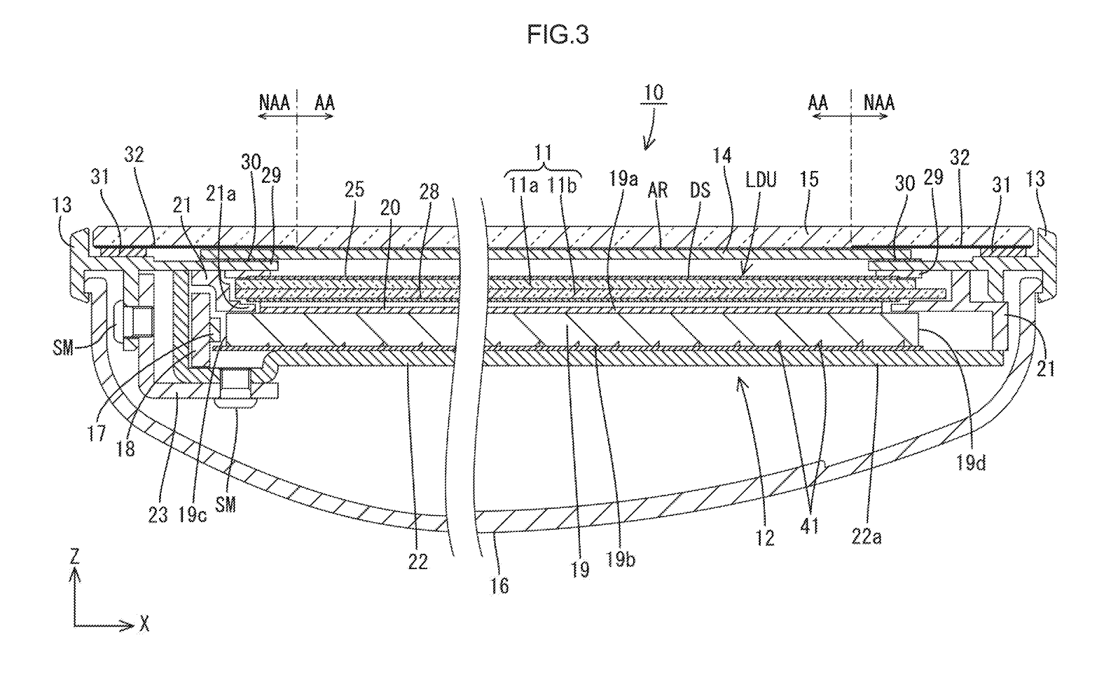

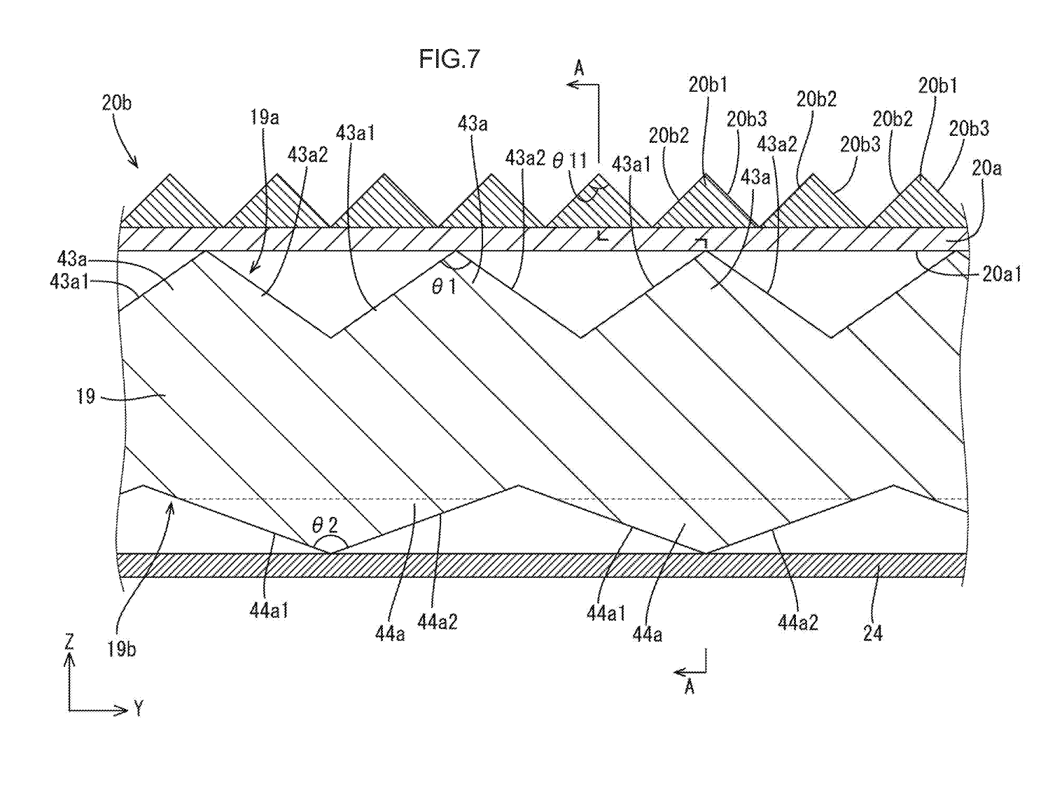

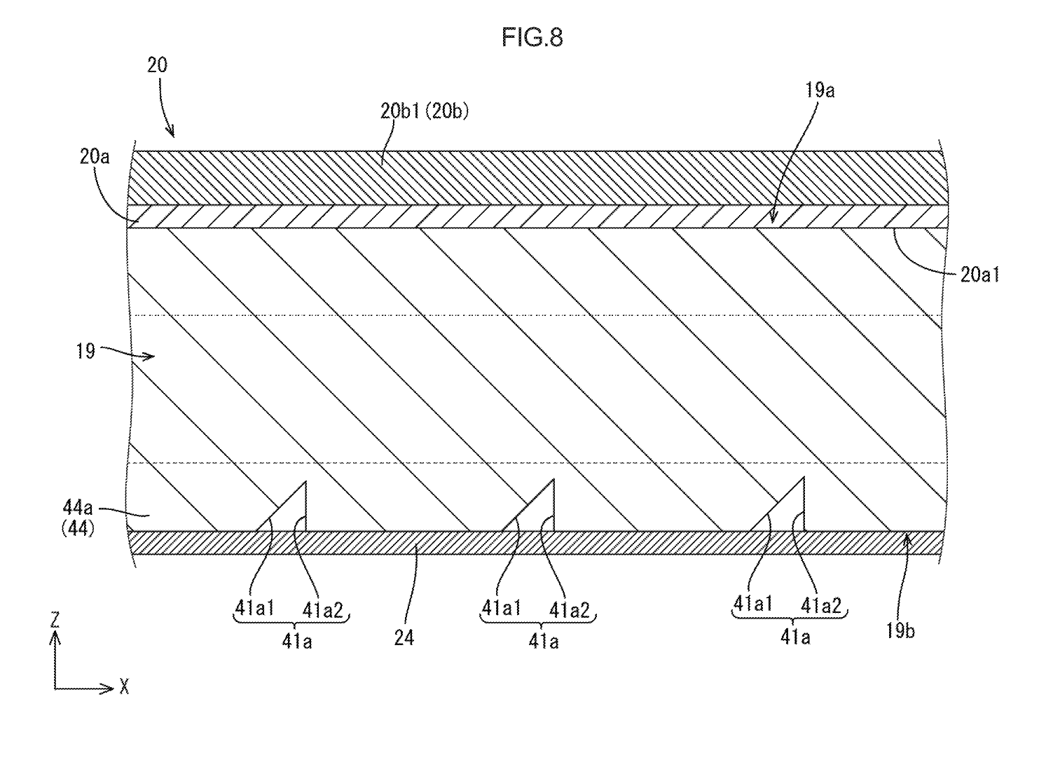

A first embodiment will be described with reference to FIGS. 1 to 18. In this section, a liquid crystal display device 10 will be described. X-axes, Y-axes and Z-axes may be specified in the drawings. The axes in each drawing correspond to the respective axes in other drawings. The vertical direction is defined based on FIGS. 3 to 5 and the upper side and the lower side in those drawings correspond to the front and the rear of the device, respectively. The front side of the liquid crystal display device 10 may be referred to as a front-face side of the liquid crystal display device 10. In this specification, “a frontward direction” refers to a direction normal to (or perpendicular to) a display surface DS of the liquid crystal display device 10 to toward the front side.

The liquid crystal display device 10 may be used for an electronic device such as a tablet computer. As illustrated in FIG. 1, the liquid crystal display device 10 has a rectangular overall shape in a plan view. The liquid crystal display device 10 includes at least a liquid crystal display unit LDU, a touchscreen 14, a cover panel 15 (a protection panel, a cover glass), and a case 16.

The liquid crystal display unit LDU includes a liquid crystal display panel 11, a backlight unit 12 (a lighting device), and a frame 13. The backlight unit 12 is disposed behind the liquid crystal display panel 11 and configured to emit light toward the liquid crystal display panel 11. The frame 13 presses down the liquid crystal display panel 11 from the front side. The touchscreen 14 and the cover panel 15 are held in the frame 13 of the liquid crystal display unit LDU from the front side.

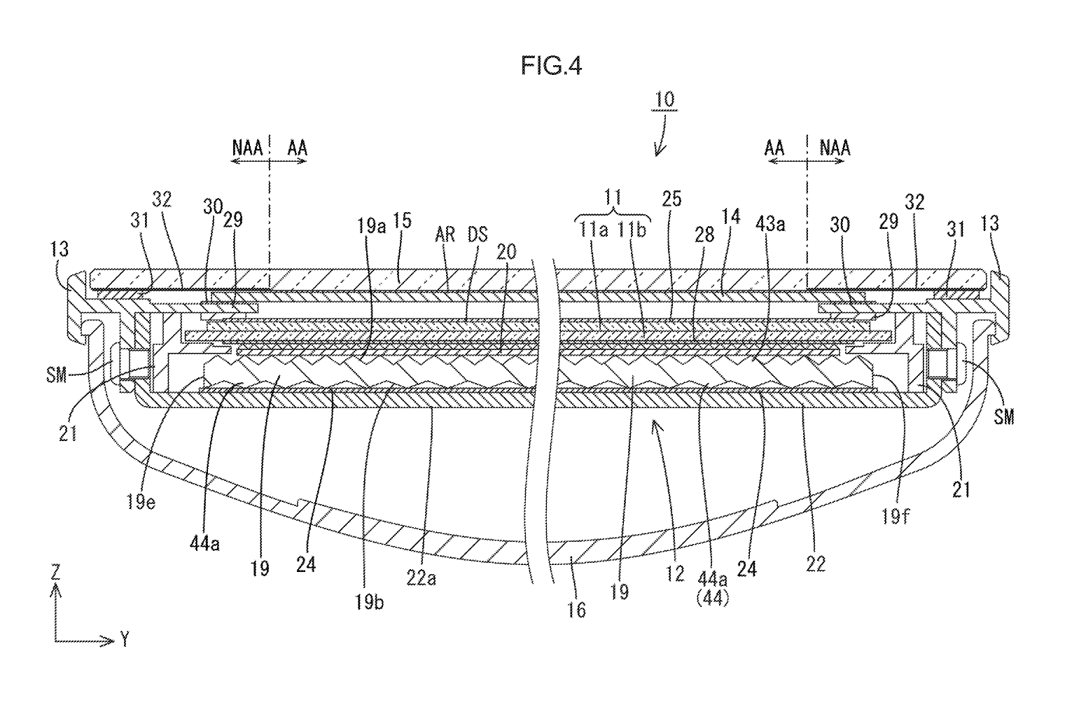

The touchscreen 14 is disposed more to the front than the liquid crystal display panel 11 with a predefined distance apart from the display surface DS of the liquid crystal display panel 11 to cover the liquid crystal display panel 11. The cover panel 15 is disposed to cover the touchscreen 14 from the front side. An anti-reflection film AR is disposed between the touchscreen 14 and the cover 15 (see FIGS. 3 and 4). A case 16 is fixed to the frame to cover the liquid crystal display unit LDU from the rear side.

Next, the liquid crystal display panel 11 included in the liquid crystal display unit LDU will be described. The liquid crystal display panel 11 has a rectangular overall shape in the plan view. The liquid crystal display panel 11 includes a pair of substrates 11a and 11b and a liquid crystal layer (not illustrated). The liquid crystal layer is between the substrates 11a and 11b. Each of the glass substrates 11a and 11b is a substantially transparent and has high light transmissivity. A sealant, which is not illustrated, is around the liquid crystal layer. The substrates 11a and 11b are bonded together with the sealant using a bonding force of the sealant.

The liquid crystal display panel 11 includes a display area AA in which images are displayed and a non-display area NAA in which no images are displayed. In FIG. 1, a longitudinal direction, a transverse direction, and a thickness direction of the liquid crystal display panel 11 correspond with the X-axis direction, the Y-axis direction, and the Z-axis direction, respectively.

One of the substrates 11a and 11b on the front side (on the front-face side) is a CF substrate 11a and one on the rear side (on the backside) is an array substrate 11b. The CF substrate 11a is slightly smaller than the array substrate 11b.

On the inner surface of the array substrate 11b (on the liquid crystal layer side), a number of thin film transistors (TFTs) that are switching components and a number of pixel electrodes are disposed in a matrix. Gate lines and source lines are routed in a grid to surround the TFTs and the pixel electrodes. Specific image signals are supplied from a control circuit, which is not illustrated, to the lines. Each pixel electrode surrounded by the gate lines and the source lines is a transparent electrode film of indium tin oxide (ITO) or zinc oxide (ZnO).

On an inner surface of the CF substrate 11a (on the liquid crystal layer side), a number of CFs are disposed to corresponding to pixels. The CFs are arranged such that three colors of R, G and B are repeatedly arranged. A black matrix (a light blocking layer) is formed in a grid pattern to surround the CFs for reducing color mixture. Common electrodes that are opposed to the pixel electrodes on the array substrate 11b are formed on surfaces of the CFs and the black matrix. The common electrodes are formed from the transparent metal film that forms the pixel electrodes.

On the inner surfaces of the substrates 11a and 11b, alignment films for alignment of liquid crystal molecules in the liquid crystal layer are formed, respectively.

A polarizing plate 25 is bonded to the outer surface of the CF substrate 11a. A complex polarizing plate 28 including layers of a polarizing plate 26 and a polarization selective reflection sheet 27 is bonded to the outer surface of the array substrate 11b. The complex polarizing plate 28 will be described in detail later.

Next, the frame 13, the touchscreen 14, the cover panel 15, and the case 16 included in the liquid crystal display unit LDU will be described.

The frame 13 is made of metal having high thermal conductivity such as aluminum. The frame 13 may be prepared by stamping. The frame 13 holds down the periphery of the liquid crystal display panel 11. The frame 13 and a chassis of the backlight unit 12 (which will be described later) hold the liquid crystal display panel 11 and components of the backlight unit 12 (e.g., a light guide plate, which will be described later) therebetween. The frame 13 and the chassis of the backlight unit 12 are fixed together with screws SM. The frame 13 includes walls that extend from the front side to the rear side. The screws SM are screwed into the cantilever wall portions from the outer side to the inner side.

The frame 13 holds the touchscreen 14 and the cover panel 15 on the front side. The frame 13 receives the peripheries of the touchscreen 14 and the cover panel 15 from the rear.

A shock absorber 29 is disposed between a front surface of the periphery of the liquid crystal display panel 11 and a rear surface of the periphery of the frame 13. A first fixing member 30 is fixed to a front surface of the inner periphery of the frame 13 and a rear surface of the outer periphery of the touchscreen 14 for fixing the peripheries of the frame 13 and the touchscreen 14 and for absorbing an impact. A second fixing member 31 is fixed to a front surface of the outer periphery of the frame 13 and a rear surface of the outer periphery of the cover panel 15 and for absorbing an impact. The shock absorber 29, the first fixing member 30, and the second fixing member 31 are double-side tapes and disposed to overlap the non-display area of the liquid crystal display panel 11.

The touchscreen 14 is for inputting position information within the display surface DS of the liquid crystal display panel 11 using a fingertip of a user. The touchscreen 14 is driven using a projected capacitive touchscreen technology. The touchscreen 14 includes a predefined touchscreen pattern (an electrode pattern) formed on a glass substrate that is substantially transparent and has high light transmissivity. The touchscreen 14 has a rectangular shape in the plan view similar to the liquid crystal display panel 11.

The cover panel 15 has a rectangular shape in the plan view similar to the touchscreen 14. The cover panel 15 is a glass plate that is substantially transparent and has high light transmissivity. The cover panel 15 is formed over the touchscreen 14 via an antireflective film AR. The cover panel 15 has the rectangular shape slightly larger than the touchscreen 14. The outer periphery of the cover panel 15 is located outer than the outer periphery of the touchscreen 14.

A frame-shaped light blocking layer 32 is formed on the rear surface of the outer periphery of the cover panel 15. The frame-shaped light blocking layer 32 is formed in a frame shape in the plan view along the outer periphery of the cover panel 15. The frame-shaped light blocking layer 32 is a coating film made of black paint. The frame-shaped light blocking layer 32 is formed in a predefined area of the cover panel 15 using a printing technology such as screen printing and ink-jet printing. In the plan view, a portion of the liquid crystal display unit LDU inside the inner edge of the frame-shaped light blocking layer 32 corresponds to the display area AA of the display surface of the liquid crystal display panel 11. A portion of the liquid crystal display unit LDU outside the inner edge of the frame-shaped light blocking layer 32 corresponds to the non-display area.

The case 16 is a component of the liquid crystal display device 10 to form the back of the liquid crystal display device 10. The case 16 has a container-like shape with an opening on the front side. A bottom surface of the case 16 is curved to bulge from the front side to the rear side. The case 16 is made of resin or metal and formed into a predefined shape. The case 16 holding the liquid crystal display unit LDU therein is fixed to the frame 13 with an opening edge of the case 16 held to the frame 13 from the rear side.

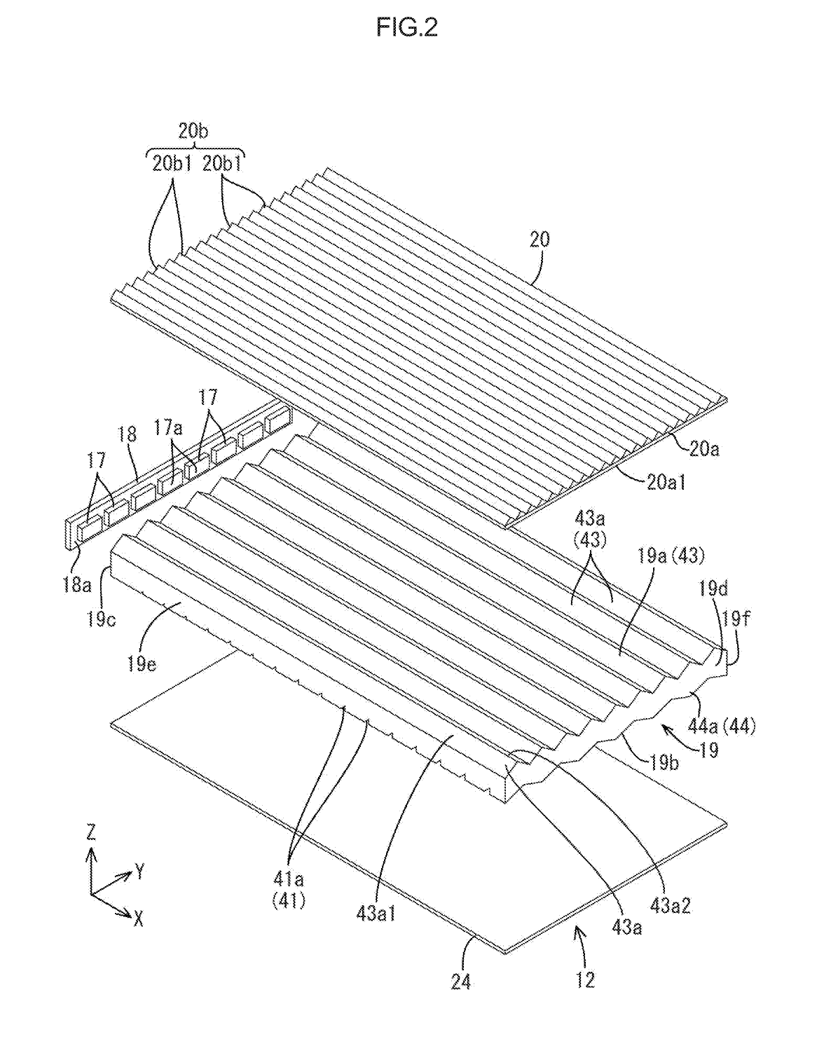

Next, the backlight unit 12 will be described. As illustrated in FIG. 1, the backlight unit 12 has a rectangular thin block overall shape similar to the liquid crystal display panel 11. As illustrated in FIGS. 2 to 4, the backlight unit 12 is a so-called edge light type (a side light type) lighting unit. The backlight unit 12 includes light emitting diodes (LEDs) 17 (an example of point light sources), an LED board 18 (a light source board), a light guide plate 19, a reflection sheet 24 (a reflection member), an optical sheet 20, a light blocking frame 21, a chassis 22, and a heat dissipation member 23. The LEDs 17 are light sources. The LEDs 17 are mounted on the LED board 18. Light from the LEDs 17 enters the light guide plate 19. The reflection sheet 24 reflects light from the light guide plate 19. The optical sheet 20 is layered on the light guide plate 19. The light blocking frame 21 holds down the light guide plate 19 from the front side. The chassis 22 holds the LED board 18, the light guide plate 19, the optical sheet 20, and the light blocking frame 21 therein. The heat dissipation member 23 is mounted to contact the outer surface of the chassis 22.

Each LED 17 includes an LED chip that is disposed on a board and sealed with a resin. The board is fixed to the LED board 18. Each LED chip mounted on the board has a main wavelength of emitting light in a single color of blue. In the resin that seals the LED chip, phosphors that emit a certain color of light when excited by the blue light emitted by the LED chip are dispersed. An overall color of light emitted by the phosphors is substantially white. A surface of each LED 17 opposite from a mounting surface thereof that is mounted to the LED board 18 is a light emitting surface 17a, that is, the LED 17 is a top surface light emitting type.

The LED board 18 has an elongated plate shape and is held inside the chassis 22 along the transverse direction of the light guide plate 19. The LED board 18 is held in a position such that the longitudinal direction and the transverse direction correspond with the Y-axis direction and the Z-axis direction, respectively. The LEDs 17 are mounted on a plate surface 18a of the LED board 18 facing the light guide plate 18. The LEDs 17 are arranged in line along the longitudinal direction of the LED board 18 (a transverse direction of the light guide plate 19, the X-axis direction) at intervals. The LEDs 17 mounted on the LED board 18 are opposed to the end surface of the light guide plate 19 with respect to the transverse direction with a predefined gap. The LED board 18 is mounted to a portion of the short side of the chassis 22, which will be described later.

A base of the LED board 18 is made of metal such as aluminum or ceramic. A trace for supplying driving power to the LEDs 17 is formed on a surface of the base via an insulating layer. The trace is made from a metal film such as a copper foil and connects the LEDs 17 in series.

The light guide plate 19 is made of substantially transparent synthetic resin having a refractive index sufficiently larger than that of the air and high light transmissivity (e.g., acrylic resin such as PMMA). The light guide plate 19 is made from a plate having a substantially rectangular thin block shape similar to the liquid crystal display panel 11. The light guide plate 19 has a rectangular shape in the plan view similar to the liquid crystal display panel 11. The light guide plate 19 is prepared by injection molding. In the drawings, the longitudinal direction, the transverse direction, and the thickness direction of the light guide plate 19 correspond with the X-axis direction, the Y-axis direction, and the Z-axis direction, respectively.

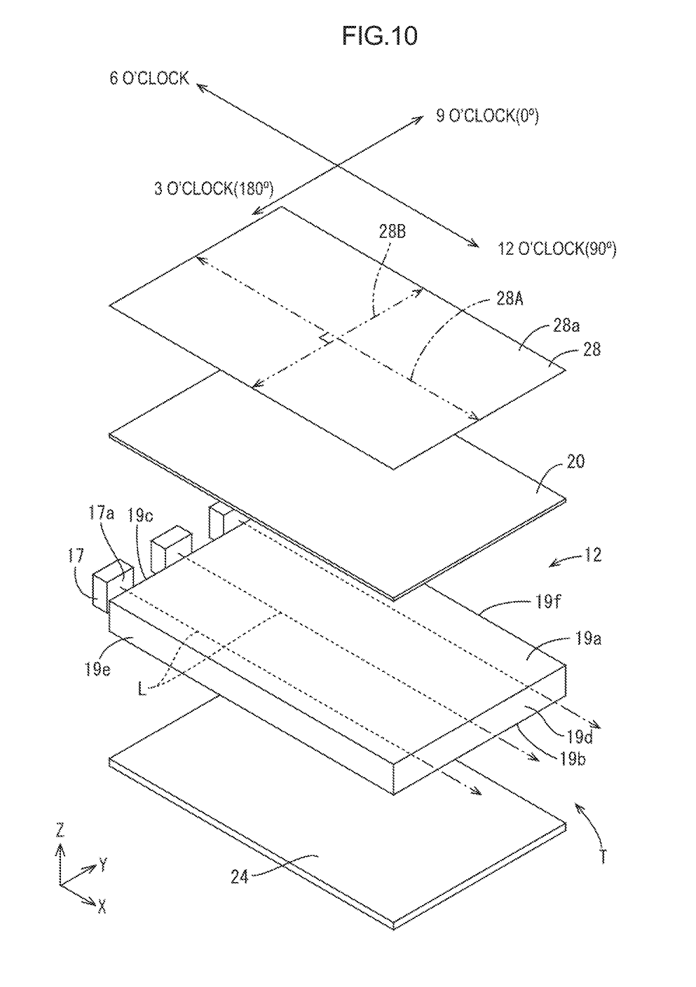

As illustrated in FIGS. 3 and 4, the light guide plate 19 is disposed directly below the liquid crystal display panel 11 and the optical sheet 20 such that the plate surfaces of the light guide plate 19 (the surfaces having larger areas) are located on the front side and the rear side in the chassis 22. One of end surfaces on the short side of the light guide plate 19 (short end surfaces) is opposed to the LEDs 17. An optical axis L of light emitted by each LED 17 (see FIG. 10) extends perpendicular to the light emitting surface 17a and along the longitudinal direction of the light guide plate 19.

The light guide plate 19 includes a front plate surface 19a, a rear plate surface 19b, a pair of short end surfaces 19c and 19d, and a pair of long end surfaces 19e and 19f. The short end surfaces 19c and 19d are parallel to each other along a transverse direction (the X-axis direction). The long end surfaces 19e and 19f are parallel to each other along a longitudinal direction (the Y-axis direction). The pair of the short end surfaces 19c and 19d and the pair of the long end surfaces 19e and 19f form a periphery of the light guide plate 19.

The front plate surface 19a of the light guide plate 19 (on the light emitting side) is configured as a light exiting surface 19a through which light exits toward the optical sheet 20 and the liquid crystal display panel 11. The rear plate surface 19b of the light guide plate 19 may be referred to as a rear surface 19b where appropriate. The rear surface 19b is opposed to the reflection sheet 24 within the chassis 22. The rear surface 19b of the light guide plate 19 is formed from rear unit prisms 44a of a rear prism portion 44, which will be described later. The rear unit prisms 44a include light reflecting portions 41.

The short end surface 19c of the pair of the short end surfaces 19c and 19d opposed to the LEDs 17 is configured as a light entering surface 19c through which light emitted by the LEDs 17 enters. The other short end surface 19d is configured as an opposite end surface 19d that is arranged opposite from the light entering surface 19c.

The long end surface 19e of the pair of the long end surfaces 19e and 19f on the right relative to the LEDs 17 may be referred to as a right end surface 19e where appropriate. The long end surface 19f on the left relative to the LEDs 17 may be referred to as a left end surface 19f where appropriate.

Rays of the light entering the light guide plate 19 through the light entering surface 19c may be totally reflected by the light exiting surface 19a or the rear surface 19b or repeatedly reflected by the reflection sheet 24 that covers the rear surface 19b. With the reflection, the light transmits through the light guide plate 19.

A material of the light guide plate 19 may be acrylic resin (e.g., PMMA). In this case, the light guide plate 19 may have a refractive index of about 1.49 and a critical angle of about 42°.

The reflection sheet 24 is disposed on the rear surface 19b of the light guide plate 19. The reflection sheet 24 reflects the light rays that have entered the light guide plate 19 toward the front side (i.e., the light exiting surface 19a side). The reflection sheet 24 may be formed from a white thin foamed plastic sheet (e.g., a foamed polyethylene terephthalate sheet) and in a size to cover the entire rear surface 19b. The reflection sheet 24 is sandwiched between a bottom plate 22a of the chassis 22 and the rear surface 19b of the light guide plate 19 and held in the chassis 22.

An end portion of the reflection sheet 24 on the light entering surface 19c side is located outer than the light entering surface 19c. The end portion outer than the light entering surface 19c reflects the light from the LEDs 71 to increase the light entering efficiency for the light entering surface 19c.

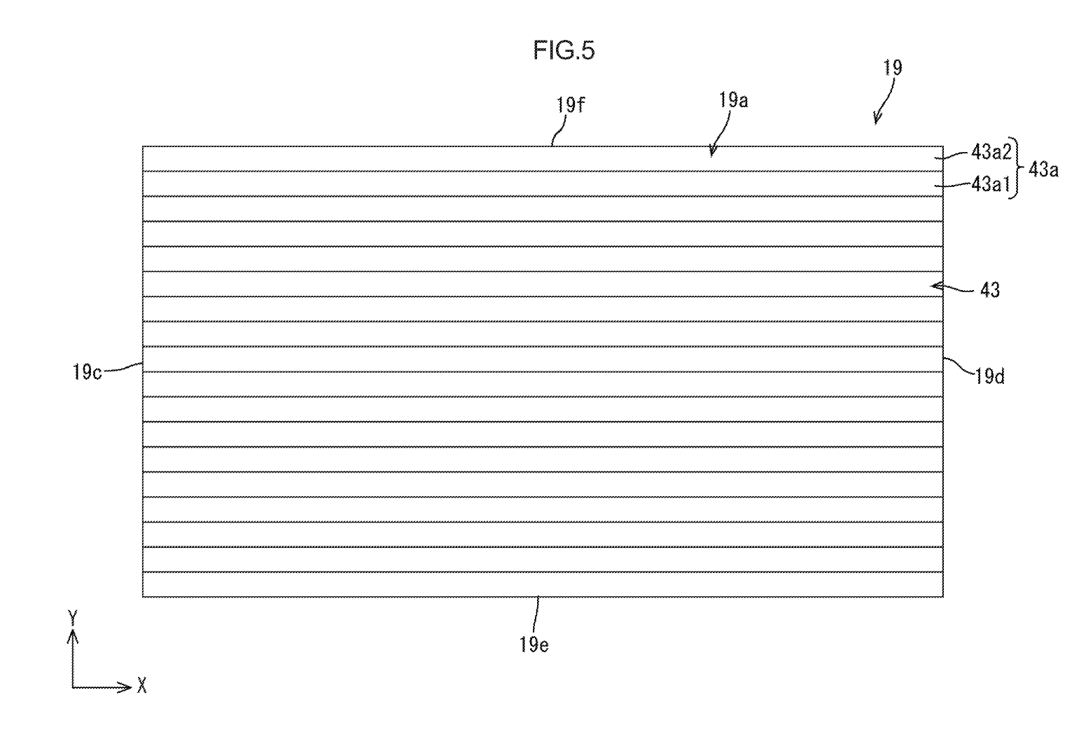

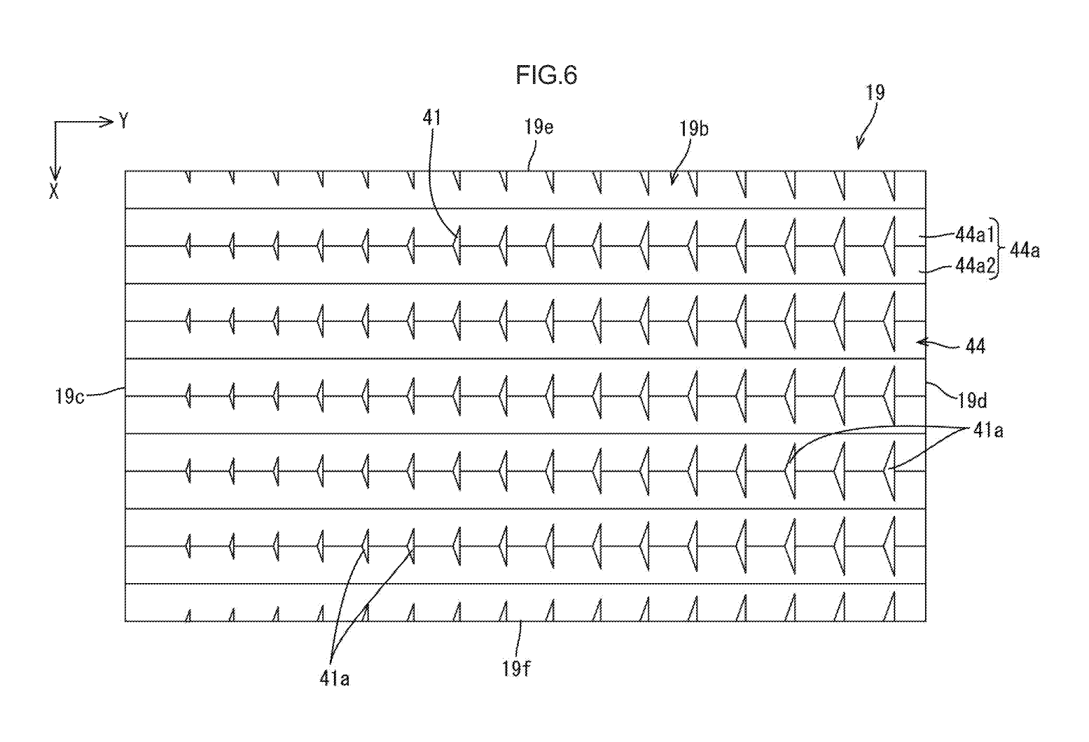

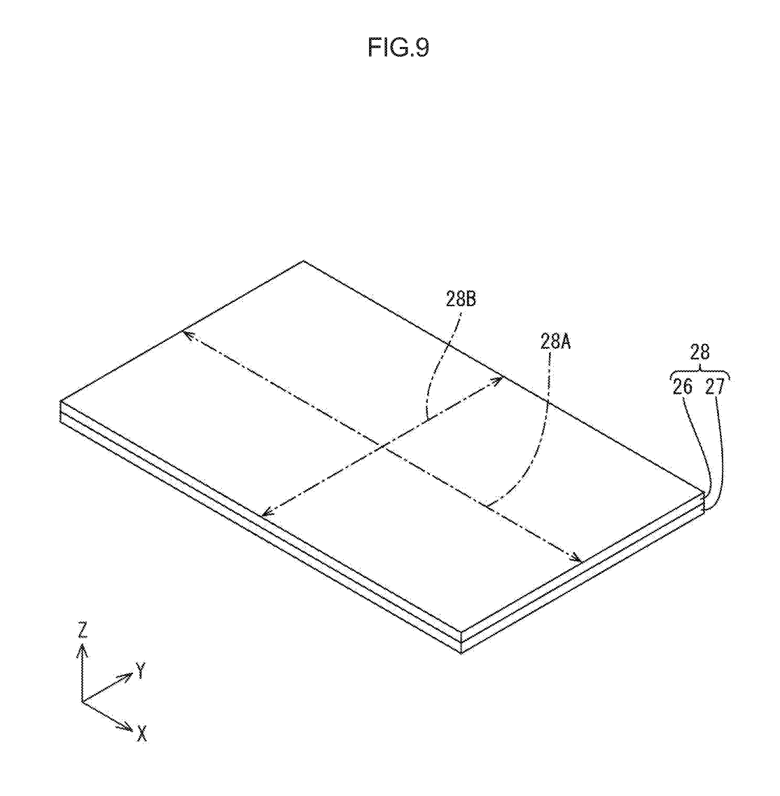

As illustrated in FIGS. 6 and 9, the exiting light reflecting portion 41 is formed in the rear surface 19b of the light guide plate 19 for reflecting the light transmitting through the light guide plate 19 to increase light rays exiting through the light exiting surface 19a. The exiting light reflecting portion 41 includes the unit reflecting portions 41a each having a groove shape (a triangular groove shape). Each unit reflecting portion 41a has a right-triangular notch shape in a cross section along the Y-axis direction. As illustrated in FIGS. 5 and 6, the unit reflecting portions 41a are arranged in lines at intervals along the X-axis direction (the transverse direction of the light guide plate 19). The lines of the unit reflecting portions 41a are arranged along the Y-axis direction (the longitudinal direction of the light guide plate 19). In this embodiment, the intervals of the unit reflecting portions 41a in the longitudinal direction of the light guide plate 19 (a direction parallel to the optical axis of the LED 17) are about constant.

The unit reflecting portions 41a include sloped surfaces 41a 1 and vertical surfaces 41a2. The sloped surfaces 41a 1 decline from the rear surface 19b toward the light exiting surface 19a as approaching from the light entering surface 19c side of the light guide plate 19 toward the opposite end surface 19d side. The vertical surfaces 41a2 face the light entering surface 19c and extend from the rear surface 19b side toward the light exiting surface 19a side.

The sloped surfaces 41a1 of the unit reflecting portions 41a on the light entering surface 19c side reflect the light rays such that some of the rays have incidences that do not exceed the critical angle relative to the light exiting surface 19a to increase the rays that exit through the light exiting surface 19a.

The unit reflecting portions 41 gradually increase in size as a distance from the light entering surface 19c (or the LEDs 17) increases in the longitudinal direction of the light guide plate 19 (the X-axis direction). Namely, the sloped surfaces 41a 1 and the vertical surfaces 41a2 of the unit reflecting portions 41a gradually increase in area as the distance from the light entering surface 19c (or the LEDs 17) increases.

The light rays entering the light guide plate 19 through the light entering surface 19c and transmitting through the light guide plate 19 are reflected by the sloped surfaces 41a 1 of the unit reflecting portions 41a of the exiting light reflecting portion 41 toward the front side. The light rays directed toward the front side have the incidences equal to or smaller than the critical angle relative to the light exiting surface 19a (or the front prism portion 43) and thus exit through the light exiting surface 19a.

The exiting light reflecting portion 41 that includes the unit reflecting portions 41a is formed in the rear surface 19b of the light guide plate 19. According to the configuration, the light rays entering through the light entering surface 19c are less likely to unevenly exit the light guide plate 19 in an area close to the light entering surface 19c. Therefore, more light rays reach the opposite end surface 19d and spread in the longitudinal direction of the light guide plate 19. The spreading light rays exit through the light exiting surface 19a. Namely, the exiting light reflecting portions 41 have functions for collecting the light rays exiting from the light exiting surface 19a relative to the longitudinal direction of the light guide plate 19 (the X-axis direction) to direct the light rays to travel in directions closer to the frontward direction of the liquid crystal display device 10.

Although the unit reflecting portions 41a have the functions to collect the light rays with respect to the longitudinal direction of the light guide plate 19 (the X-axis direction), the unit reflecting portions 41a rarely have functions to collect the light rays with respect to the transverse direction of the light guide plate 19 (the Y-axis direction).

Next, a light collecting function of the light guide plate 19 with respect to the transverse direction (the Y-axis direction) will be described. The light guide plate 19 includes the front prism portion 43 and the rear prism portion 44 as a light collecting portion for collecting the light rays with respect to the transverse direction (the Y-axis direction) to direct the light rays to travel in the frontward direction.

First, the front prism portion 43 (an example of a light collecting portion) which forms the light exiting surface 19a of the light guide plate 19 will be described. The front prism portion 43 is integrally formed with the light guide plate 19 as a portion of the light guide plate 19. The front prism portion 43 has a function for collecting the light rays toward the frontward direction of the liquid crystal display device 10 in the transverse direction of the light guide plate 19 and directing the light rays from the light guide plate 19 to the optical sheet 20 on the front side.

The front prism portion 43 includes front unit prisms 43a. Each front unit prism 43a has an elongated shape that extends along the longitudinal direction of the light guide plate 19 (the Y-axis direction). The front unit prisms 43a are adjacent to one another along the transverse direction of the light guide plate 19 (the X-axis direction). The front unit prisms 43a have the same shape and the same size. The front unit prisms 43a have dimensions in the transverse direction (widths) which are constant in the longitudinal direction.

The front unit prisms 43a protrude from the rear side toward the front side. Each front unit prism 43a has a right-triangular shape with a vertex on the front side when viewed in the X-axis direction. Each front unit prism 43a has a pair of sloped surfaces 43a 1 and 43a2 that are adjacent to each other and form the vertex. The sloped surfaces 43a 1 and 43a2 have elongated shapes. The sloped surfaces 43a 1 and 43a2 have rectangular shapes that are elongated along the longitudinal direction of the light guide plate 19 (band shapes). The sloped surface 43a 1 is arranged on the right end surface 19e side of the light guide plate 19 and the sloped surface 43a2 is arranged on the left end surface 19f side of the light guide plate 19.

Angles θ1 of the vertexes of the front unit prisms 43a are set to a predefined obtuse angle (i.e., larger than 90°). Specifically, the angles θ1 are set in a range from 100° to 150°, more preferably, about 110°. The angles θ1 of the vertexes of the front unit prisms 43a are set larger than angles θ11 of vertexes of light exiting-side unit prisms 42a of the optical sheet 20, which will be described later.

The front prism portion 43 having such a configuration adds anisotropic light collecting effects, which will be described below, to the light rays that have traveled through the light guide plate 19 and reached the light exiting surface 19a.

If the light rays in the light guide plate 19 enter the sloped surfaces 43a1 and 43a2 of the front unit prisms 43a of the light exiting surface 19a with incidences equal to or smaller than the critical angle, the light rays are refracted at the sloped surfaces 43a 1 and 43a2 and exit to the outside. The light rays are collected by the front unit prisms 43a of the front prism portion 43 with respect to the transverse direction of the light guide plate 19 to direct the light rays to travel in directions closer to the frontward direction.

If the light rays in the light guide plate 19 enter the sloped surfaces 43a 1 and 43a2 of the front unit prisms 43a of the light exiting surface 19a with incidences larger than the critical angle, the light rays are totally reflected by the sloped surfaces 43a1 and 43a2 and returned toward the rear surface 19b. The returned light rays may be reflected by the rear surface 19b of the light guide plate 19 or the reflection sheet 24 and directed toward the front side (the light exiting surface 19a side).

Because of effects of collecting light rays with respect to the transverse direction of the light guide plate 19 exerted by the front unit prisms 43a of the front prism portion 43, the light rays exiting through the light exiting surface 19a are directed in the frontward direction of the liquid crystal display device 10 (a direction normal to the display surface DS).

Next, the rear prism portion 44 of the rear surface 19b of the light guide plate 19 (an example of a light collecting portion) will be described. The rear prism portion 44 is integrally formed with the light guide plate 19 as a portion of the light guide plate 19. The rear prism portion 44 includes the rear unit prisms 44a. Each rear unit prism 44a has an elongated shape that extends along the longitudinal direction of the light guide plate 19 (the Y-axis direction). The rear unit prisms 44a are adjacent to one another along the transverse direction of the light guide plate 19 (the X-axis direction). The rear unit prisms 44a have the same shape and the same size. The rear unit prisms 44a have dimensions in the transverse direction (widths) which are constant in the longitudinal direction. The dimensions of the rear unit prisms 44a in the transverse direction (the widths) are larger than those of the front unit prisms 43a.

The rear unit prisms 44a protrude from the front side toward the rear side of the light guide plate 19. Each rear unit prism 44a has a right-triangular shape with a vertex on the rear side when viewed in the X-axis direction. Each of the rear unit prisms 44a at ends of the lines of the rear unit prisms 44a in the transverse direction of the light guide plate 19 in this embodiment has a half shape of another rear unit prism 44a cut along a center line drawn from the vertex (i.e. a right triangle shape). Each of the rear unit prisms 44a includes either one of the sloped surfaces 44a 1 and 44a2.

Each rear unit prism 44a has a pair of sloped surfaces 44a 1 and 44a2 that are adjacent to each other and form the vertex. The sloped surfaces 44a 1 and 44a2 have elongated shapes. The sloped surfaces 44a1 and 44a2 have rectangular shapes that are elongated along the longitudinal direction of the light guide plate 19 (band shapes). The sloped surface 44a1 is arranged on the right end surface 19e side of the light guide plate 19 and the sloped surface 44a2 is arranged on the left end surface 19f side of the light guide plate 19.

Angles θ2 of the vertexes of the rear unit prisms 44a are set to a predefined obtuse angle (i.e., larger than 90°). Specifically, the angles θ2 are set in a range from 100° to 150°, more preferably, about 140°. The angles θ2 of the vertexes of the rear unit prisms 44a are set larger than the angles θ1 of the front unit prisms 43a described earlier and angles θ11 of vertexes of unit prisms 20b1 of the optical sheet 20, which will be described later.

The rear prism portion 44 having such a configuration adds anisotropic light collecting effects, which will be described below, to the light rays that have traveled through the light guide plate 19 and reached the rear surface 19b.

If the light rays in the light guide plate 19 enter the sloped surfaces 44a1 and 44a2 of the rear unit prisms 44a of the rear surface of the light guide plate 19 with incidences larger than the critical angle, the light rays are totally reflected by the sloped surfaces 44a1 and 44a2 and directed toward the front side of the light guide plate 19 on which the front prism portion 43 is formed.

If the light rays in the light guide plate 19 enter the sloped surfaces 44a 1 and 44a2 of the rear unit prisms 44a of the rear surface of the light guide plate 19 with incidences equal to or smaller than the critical angle, the light rays are refracted at the sloped surfaces 44a1 and 44a2 and exit toward the reflection sheet 24. The light rays exiting toward the reflection sheet 24 are reflected by the reflection sheet 24 and enter the light guide plate 19 through the sloped surfaces 44a1 and 44a2 of the rear unit prisms 44. The light rays travel toward the front side of the light guide plate 19 on which the front prism portion 43 is formed.

The light rays traveling toward the front side of the light guide plate 19 as described above are repeatedly reflected inside the light guide plate 19 and finally reflected by the exiting light reflecting portion 41 formed in the rear surface 19b of the light guide plate 19. Then, the light rays are refracted at the sloped surfaces 43a 1 and 43a2 of the front unit prisms 43a and exit the light guide plate 19. The light rays that have exited the light guide plate 19 are collected toward the frontward direction in the transverse direction of the light guide plate 19 because of the optical property of the rear prism portion 44.

With the rear surface 19b of the light guide plate 19 including the rear prism portion 44, the light rays exiting from the front prism portion 43 to the outside are collected toward the frontward direction in the transverse direction of the light guide plate 19.

With the front prism portion 43 and the rear prism portion 44 included in the light guide plate 19, the light rays transmitting through the light guide plate 19 are more likely to be repeatedly reflected. As a result, the light rays properly spread out inside the light guide plate 19.

The unit reflecting portions 41a of the exiting light reflecting portion 41 are formed such that portions of the rear unit prisms 44a of the rear prism portion 44 are cut out. An amount of light reflected by the exiting light reflecting portion 41 (the unit reflecting portions 41a) tends to be proportional to a surface area thereof. Therefore, the size (the surface area) of the exiting light reflecting portion 41 (the unit reflecting portions 41a) is set to achieve a necessary amount of the reflected light.

Next, the optical sheet 20 will be described in detail. The optical sheet 20 has a light collecting function for collecting the light rays exiting from the light guide plate 19 in the transverse direction of the light guide plate 19 to adjust directions of the light rays closer to the frontward direction.

The optical sheet 20 has a rectangular shape in a plan view similar to the liquid crystal display panel 11. The optical sheet 20 is laid on the light guide plate 19 to cover the light exiting surface 19a. The optical sheet 20 is between the liquid crystal display panel 11 and the light guide plate 19. The optical sheet 20 passes the light rays exiting from the light guide plate 19 therethrough. The optical sheet 20 adds the specific optical effects to the light rays that are passed through the optical sheet 20 and directs the light rays toward the liquid crystal display panel 11.

The optical sheet 20 is a prism sheet including a sheet base and prisms that are formed on the front side of the sheet base. The optical sheet 20 includes a sheet base 20a, a light entering surface 20a1, and a prism portion 20b. The sheet base 20a has a rectangular sheet shape in a plan view. The light entering surface 20a 1 forms the rear surface of the sheet base 20a. The light rays exiting from the light guide plate 19 enters through the light entering surface 20a1. The prism portion 20b is formed on the front surface of the sheet base 20a. The prism portion 20b has light-collecting anisotropy (light collecting property in the transverse direction).

The sheet base 20a is made of substantially transparent synthetic resin such as polyethylene terephthalate (PET). The sheet base 20a has a refractive index of about 1.67. The sheet base 20a in this embodiment is made of PET.

The prism portion 20b includes unit prisms 20b1. The unit prism 20b1 is integrally formed with a front surface of the sheet base 20a. The unit prisms 20b1 are made of material including photo-curable resin such as ultraviolet curable resin. The resin used for the unit prisms 20b1 may include acrylic resin such as PMMA. The refractive index of each unit prism 20b1 may be about 1.59.

The unit prisms 20b1 protrude from the rear side toward the front side of the sheet base 20a. Each unit prism 20b1 has a right-triangular shape with a vertex on the front side when viewed in the X-axis direction. Each unit prism 20b1 has a pair of sloped surfaces 20b2 and 20b3 that are adjacent to each other and form the vertex. The sloped surfaces 20b2 and 20b3 have elongated shapes. The sloped surfaces 20b2 and 20b3 have rectangular shapes that are elongated along the longitudinal direction of the sheet base 20a (band shapes). The sloped surface 20b2 is arranged on the right relative to the LEDs 17 and the sloped surface 20b3 is arranged on the left relative to the LEDs 17.

Widths (dimensions in the transverse direction) of the unit prisms 20b1 are constant in the longitudinal direction. The widths of the unit prisms 20b1 are smaller than the widths of the front unit prisms 43a of the light guide plate 19. The unit prisms 20b1 are arranged without gaps in the transverse direction of the sheet base 20a.

The angles θ11 of the vertexes of the unit prisms 20b1 are set to about an right angle (about 90°). The angles θ11 of the vertexes of the unit prisms 20b1 of the optical sheet 20 are smaller than the angles θ1 of the vertexes of the front unit prisms 43a of the light guide plate 19.

The light rays directed by the light guide plate 19 toward the optical sheet 20 having such a configuration transmit through an air layer between the light guide plate 19 and the optical sheet 20 and enter the sheet base 20a of the optical sheet 20 with refraction at the light entering surface 20a1. The light rays that have entered the sheet base 20a and transmitted through the sheet base 20a are refracted at an interface between the sheet base 20a and the prism portion 20b according to incidences. The refracted light rays enter the unit prisms 20b1 and reach the sloped surfaces 20b2 and 20b3. If incidences of the light rays that have reached the sloped surfaces 20b2 and 20b3 are equal to or larger than the critical angle, the light rays are totally reflected to the sloped surfaces 20b2 and 20b3 and returned to the sheet base 20a. If the incidences are smaller than the critical angle, the light rays are refracted at the sloped surfaces 20b2 and 20b3 and exit to the outside.

The light rays exiting from the sloped surfaces 20b2 and 20b3 to the outside and traveling to the adjacent unit prisms 20b1 enter the adjacent unit prisms 20b1 to which the light rays travel, that is, the light rays are returned to the sheet base 20a.

The light rays that have transmitted through the prism portion 20b of the optical sheet 20 and exited to the front side are collected with respect to the transverse direction (the Y-axis direction) to direct the light rays to travel in directions closer to the frontward direction.

The angles θ11 of the vertexes of the unit prisms 20b1 of the optical sheet 20 are smaller than the angles θ1 of the vertexes of the front unit prisms 43a of the light guide plate 19 and the angles θ2 of the vertexes of the rear unit prisms 44a. Therefore, the prism portion 20b retroreflects the larger number of the light rays and limits angles of the exiting light rays to a narrower range in comparison to the front prism portion 43 and the rear prism portion 44. Namely, the prism portion 20b has the strongest light collecting property.

Next, the light blocking frame 21, the chassis 22, and the heat dissipating member 23 will be described.

The light blocking frame 21 has a frame shape that covers a periphery of the light guide plate 19. The light blocking frame 21 has a function for holding the periphery of the light guide plate 19 from the front side. The light blocking frame 21 is in black and has light blocking property. The light blocking frame 21 is a processed piece made of synthetic resin. The light blocking frame 21 is fixed to the chassis 22 using members that are not illustrated.

The light blocking frame 21 includes a covering portion 21a that is disposed between the LEDs 17 on the LED board 18 and the end portions of the liquid crystal display panel 11 and the optical sheet 20. The covering portion 21a has a function of a visor that covers the light entering surface 19c of the light guide plate 19. Some of the light rays emitted by the LEDs 17 do not enter the light guide plate 19 through the light entering surface 19b or leak to the outside through the rear surface 19b, the right end surface 19e, or the left end surface 19f. The covering portion 21a has a function for restricting those light rays from directly enter the end portions of the liquid crystal display panel 11 and the end portions of the optical sheet 20.

The chassis 22 has a shallow container overall shape with an opening on the front side. The chassis 22 are formed from a sheet metal product having high thermal conductivity such as an aluminum sheet or an electrogalvanized steel sheet (SECC). The bottom plate 22a of the chassis 22 has a rectangular shape in a plan view similar to the liquid crystal display panel 11. Side plates 22b project upright from the edges of the bottom plate 22a.

The chassis 22 holds the reflection sheet 24, the light guide plate 19, the optical sheet 20, and the liquid crystal display panel 11 that are laid in this sequence on the bottom plate 22a. The side plates 22b are disposed to surround those components that are laid on one another.

The LED board 18 is fixed to an inner surface of the side plate 22b with a double-sided adhesive tape attached to a plate surface of the LED board 18 opposite from the mounting surface 18a on which the LEDs 17 are mounted. A driver circuit board for controlling driving of the liquid crystal display panel 11, an LED driver circuit board for supplying driving power to the LEDs 17 (not illustrated), and a touchscreen driver circuit board for controlling driving of the touchscreen 14 (not illustrated) are attached to a rear plate surface of the bottom plate 22a of the chassis 22.

The heat dissipating member 23 is formed from a sheet metal having high thermal conductivity such as an aluminum sheet. The heat dissipating member 23 has an elongated shape that extends along one of short edges of the chassis 22. As illustrated in FIG. 3, the heat dissipating member 23 has an L-shaped cross section when viewed in the Y-axis direction. The heat dissipating member 23 is fixed to the frame 13 and the bottom plate 22a to connect the frame 13 to the bottom plate 22a of the chassis 22 with screws SW. The heat dissipating member 23 is configured to release heat generated by the LEDs 17 to the bottom plate 22a of the chassis 22.

As described above, the liquid crystal display device 10 includes the backlight unit 12 having the light collecting functions for collecting the light rays with respect the X-axis direction and the Y-axis direction to direct the light rays to travel in directions closer to the frontward direction. The light collecting function with respect to the X-axis direction is performed by the exiting light reflecting portion 41 formed in the rear surface 19b of the light guide plate 19.

The light collecting functions with respect to the Y-axis direction is performed by the front prism portion 43 and the rear prism portion 44 of the light guide plate 19 and the prism portion 20b of the optical sheet 20. In this embodiment, if the light rays from the light guide plate 19 enter the light entering surface 20a 1 formed from the rear surface of the optical sheet 20 (the rear surface of the sheet base) with incidences in a range from 23° to 40° with respect to the Y-axis direction (the transverse direction of the light guide plate 19 and the optical sheet 20), the angles of the light rays exiting from the sloped surfaces 20b2 and the 20b3 of the unit prisms 20b1 on the front side of the optical sheet 20 are in a range ±10° of the frontward direction, where the angle of the exiting light ray parallel to the frontward direction is defined 0°.

The Y-axis direction corresponds with an arrangement direction of the front prism portion 43 (the front unit prisms 43a) and the rear prism portion 44 (the rear unit prisms 44a) of the light guide plate 19 and an arrangement direction of the prism portion 20b (the unit prisms 20b1) of the optical sheet 20.

When the light rays are collected with respect to the Y-axis direction (the transverse direction of the light guide plate 19) to direct the light rays in the frontward direction using a combination of the optical sheet 20 and the light guide plate 19, some of the light rays emitted by the backlight unit 12 and traveling in directions largely angled to the frontward direction in the Y-axis direction may concentrate in an area. Therefore, in the liquid crystal display device 10 including the backlight unit 12 having the function for collecting the light rays with respect to the Y-axis direction, a transmission axis of the complex polarizing plate 28 disposed on the rear side of the liquid crystal display panel 11 is aligned with the X-axis direction so that the concentration of the light rays and a decrease in frontward brightness are less likely to occur.

The complex polarizing plate 28 will be described. FIG. 9 is a perspective view schematically illustrating the complex polarizing plate 28. The complex polarizing plate 28 mainly includes a light entering-side polarizing plate 26 and a polarization selective reflection sheet 27 that are laid on each other. The polarizing plate 26 and the polarization selective reflection sheet 27 are bonded together with an adhesive layer. The polarization selective reflection sheet 27 is disposed on the rear side of the polarizing plate 26. Namely, the polarization selective reflection sheet 27 is disposed on the light guide plate 19 (or the optical sheet 20) side and the polarizing plate 26 is disposed on the array board 11b side of the liquid crystal display panel 11. The complex polarizing plate 28 is attached to the array board 11b of the liquid crystal display panel 11 with an adhesive layer.

In the complex polarizing plate 28, the polarizing plate 26 and the polarization selective reflection sheet 27 are laid on each other with the transmission axis of the polarizing plate 26 (a second transmission axis) and the transmission axis of the polarization selective reflection sheet 27 (a first transmission axis) corresponding with each other. In the complex polarizing plate 28, the transmission axis of the polarizing plate 26 (the second transmission axis) is parallel to the transmission axis of the polarization selective reflection sheet 27 (the first transmission axis). Namely, the complex polarizing plate 28 has the transmission axis 28A that corresponds with (or parallel to) the transmission axis of the polarization selective reflection sheet 27 (the first transmission axis) and the transmission axis of the polarizing plate 26 (the second transmission axis).

The polarizing plate 26 is formed by mixing absorbers such as iodine and dichromatic dye into polymer resin and orientating the absorbers by stretching. The polarizing plate 26 is not limited to the above as long as the polarizing plate 26 is capable of converting non-polarization to linear polarization. The polarizing plate 26 has a function for passing the linearly polarized light rays (linearly polarized light rays in a first condition) entering the polarizing plate 26 with a direction of polarization (a vibration plane) parallel to the transmission axis (the second transmission axis).

The polarization selective reflection sheet 27 has a function for reflecting the linearly polarized light rays (linearly polarized light rays in a second condition) entering the polarization selective reflection sheet 27 with a direction of polarization (a vibration plane) parallel to a reflection axis. The polarization selective reflection sheet 27 has a function for passing the linearly polarized light rays (the linearly polarized light rays in the first condition) entering the polarization selective reflection sheet 27 with the direction of polarization parallel to the transmission axis (the first transmission axis). The transmission axes of the polarization selective reflection sheet 27 are perpendicular to the reflection axis.

A brightness enhancement film such as a DBEF (by 3M Company) and a Nippokusu APCF (by Nitto Denko Corporation) may be used for the polarization selective reflection sheet 27.

It may be described that the complex polarizing plate 28 has a reflection axis 28B perpendicular to the transmission axis 28A. The orientation of the reflection axis 28B corresponds with the orientation of the reflection axis of the polarization selective reflection sheet 27.

The light exiting-side polarizing plate 25 is disposed on the front side of the liquid crystal panel 11. The polarizing plate 25 is attached to the CF substrate 11a with an adhesive with the transmission axis perpendicular to the transmission axis 28A of the complex polarizing plate 28.

FIG. 10 is an exploded perspective view schematically illustrating a positional relationship between the backlight unit 12 and the complex polarizing plate 28 in a testing device T. As illustrated in FIG. 10, the complex polarizing plate 28 is placed over the optical sheet 20 with the transmission axis 28A corresponding with the X-axis direction. The testing device T includes the complex polarizing plate 28 placed over the optical sheet 20 of the backlight unit 12 in the liquid crystal display device 10 according to the first embodiment of the present invention.

The optical axis L of the light from the LEDs 17 is along the X-axis direction. In this specification, a direction perpendicular to the optical axis L (the Y-axis direction) is defined as a “light collecting direction”) of the light collecting portion (the front prism portion 43, the rear prism portion 44) in the backlight unit 12 and a direction perpendicular to the light collecting direction (i.e., a direction along the optical axis L) is defined as a (non-light collecting direction).

With the complex polarizing plate 28, the frontward brightness of the light exiting from the light guide plate 19 improves.

The orientation of the transmission axis 28A of the complex polarizing plate 28 may be described with reference to a dial plate of an imaginary clock as in FIG. 10. Specifically, “6 o'clock” of the dial plate of the imaginary clock is on the LED 17 side of the light guide plate 19 and “12 o'clock” is on the opposite end surface 19d side of the light guide plate 19 (i.e., a direction along the optical axis of the LED 17). A direction along the X-axis direction corresponds with a “12 o'clock-to-6 o'clock direction” and a direction along the Y-axis direction corresponds with a “3 o'clock-to-9 o'clock direction.”

Furthermore, the orientation of the transmission axis 28A of the complex polarizing plate 28 along the “3 o'clock to 9 o'clock” on the dial plate of the imaginary clock may be defined as “at an angle of 0°.” The orientation of the transmission axis 28A along the “12 o'clock to 6 o'clock,” that is, rotated in clockwise from the above position on the X-Y plane (i.e., along the light exiting surface 19a of the light guide plate 19) may be defined as “at an angle of 90°.”

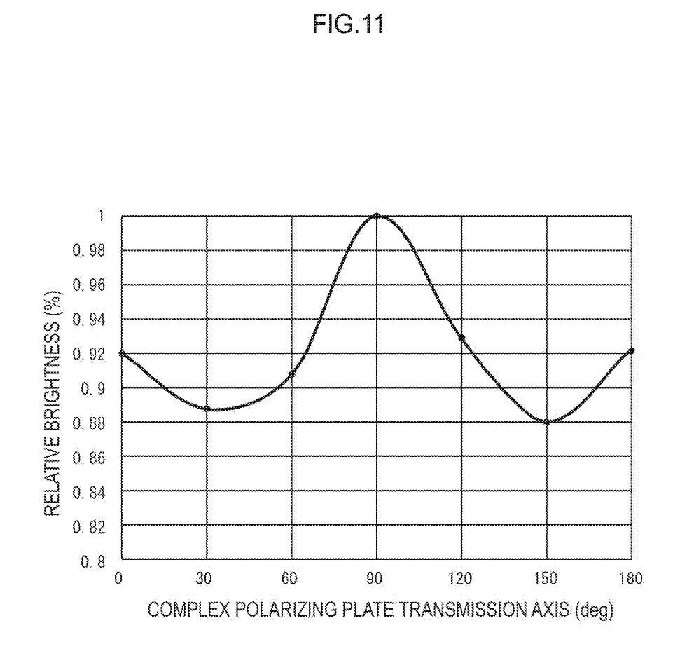

The angle of the transmission axis 28A of the complex polarizing plate 28 and the frontward brightness will be described with reference to FIG. 11. FIG. 11 is a graph illustrating a relationship between the angle of the transmission axis 28A of the complex polarizing plate 28 and relative value of the frontward brightness in the testing device. The horizontal axis of the graph in FIG. 11 represents the angle of the transmission axis 28A of the complex polarizing plate 28 and the vertical axis represents the brightness (relative brightness in %) of the light from the light guide plate 19 and transmitted through the complex polarizing plate 28 in the frontward direction (a direction normal to the complex polarizing plate 28).

In the testing device including the complex polarizing plate 28 placed over the optical sheet 20 in the backlight unit 12, light is supplied from the backlight unit 12 to the complex polarizing plate 28 and the frontward brightness of the light transmitted through the complex polarizing plate 28 was measured while the angle of the transmission axis 28A was altered. The transmission axis 28A along “3 o'clock to 9 o'clock” was defined as “at an angle of 0°” and the transmission axis 28A rotated clockwise 180° from the above position was defined as “at an angle of 180°.”

As illustrated in FIG. 11, when the transmission axis 28A was at an angle of 90°, the frontward brightness of the light exiting from the complex polarizing plate 28 was the highest. It was observed that the frontward brightness of the exiting light varied substantially symmetrically about the transmission axis 28A at 90°. When the transmission axis 28A was at 90°, the reflection axis 28B of the complex polarizing plate 28 (i.e., the reflection axis of the polarization selective reflection sheet 27) was along the “3 o'clock-to-9 o'clock” direction (the Y-axis direction). The complex polarizing plate 28 actively reflects the light rays emitted by the backlight unit 12 in directions largely angled to the frontward direction toward the plate surface of the complex polarizing plate 28 (i.e., directions at small angles relative to the plate surface of the complex polarizing plate 28). It is assumed that the reflected light rays contribute to improvement of the brightness in the frontward direction.

Next, a brightness distribution (light distribution characteristics) when the transmission axis 28A of the complex polarizing plate 28 is at 90° (i.e., the transmission axis 28A is along the “12 o'clock-to-6 o'clock” direction, the X-axis direction) will be described.

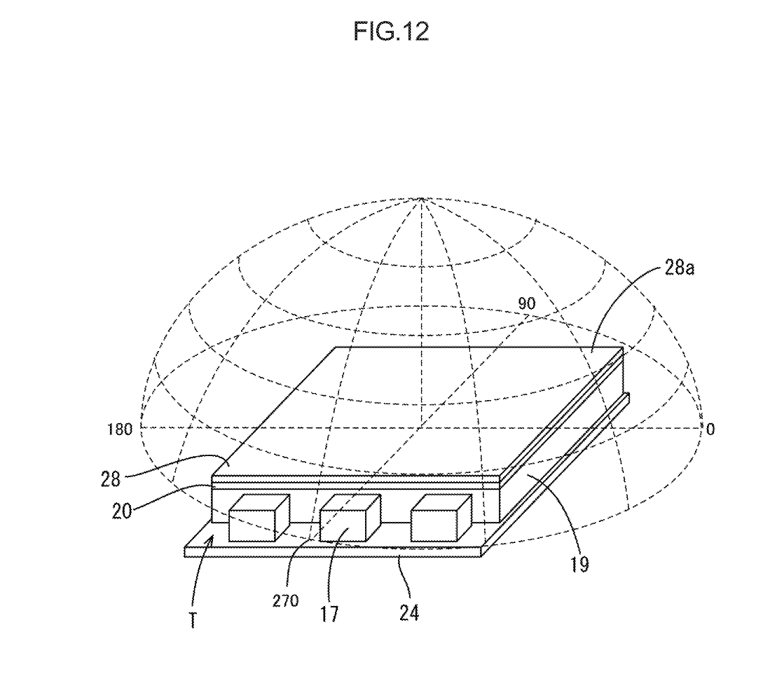

A relationship between a coordinate system representing the brightness distribution and the testing device T including the backlight unit 12 and the complex polarizing plate 28 will be described with reference to FIG. 12. FIG. 12 is a perspective view schematically illustrating the relationship between the testing device T and the coordinate system. As illustrated in FIG. 12, a hemispherical grid was set over a light exiting surface 28a in the testing device T (a front surface of the complex polarizing plate 28). A center of the hemispherical grid was at the center of the light exiting surface 28a. The angle of 180° was set on the left of the testing device T that was viewed from the LED 17 side and the angle of 0° was set on the opposite side. The angle of 270° was set on the LED 17 side and the angle of 90° was set on the opposite side.

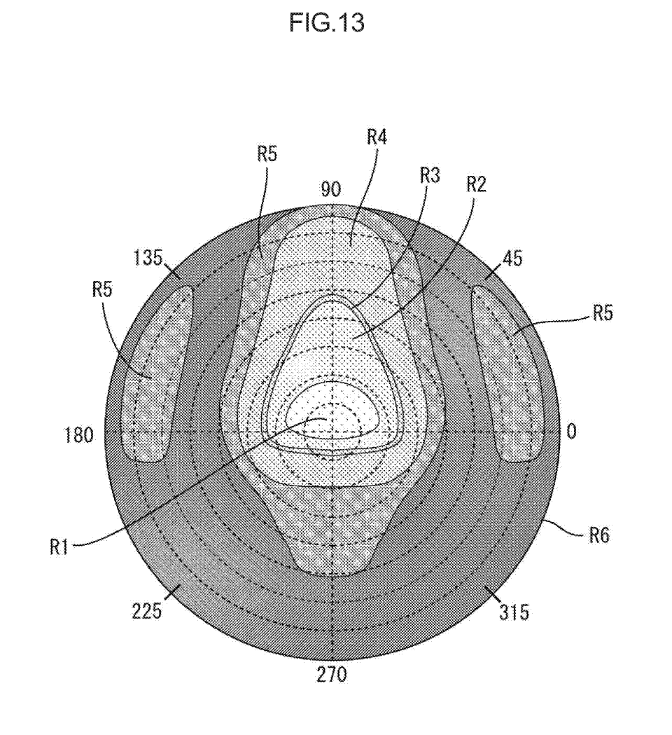

The brightness distribution (the light distribution characteristics) of the light exiting from the testing device T was measured with an optical goniometer (EZContrast by ELDIM). The results are presented in FIG. 13. FIG. 13 illustrates the brightness distribution (the light distribution characteristics) of the light exiting from the testing device T with the transmission axis 28A of the complex polarizing plate 28 at 90°.

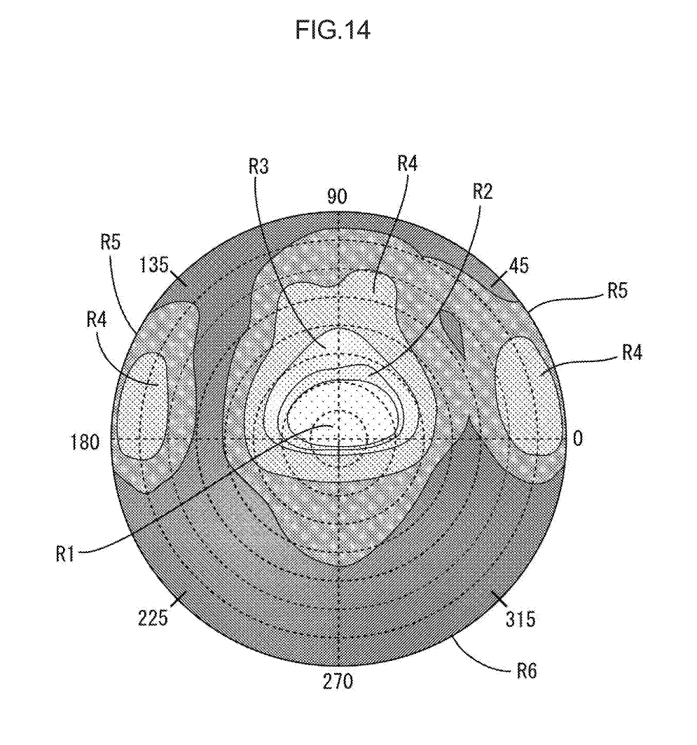

A comparative experiment was performed. The results of the comparative experiment illustrating a brightness distribution of light exiting from the testing device T with the transmission axis 28A of the complex polarizing plate 28 at 0° (i.e., the transmission axis 28A is along the “3 o'clock-to-9 o'clock” direction, the Y-axis direction) are presented in FIG. 14. FIG. 14 illustrates the brightness distribution (the light distribution characteristics) of the light exiting from the testing device T with the transmission axis 28A of the complex polarizing plate 28 at 0°.

In FIGS. 13 and 14, R1 indicates a region having the highest brightness level. R2, R3, R4, R5, and R6 indicate regions having brightness levels that become smaller in this sequence.

As illustrated in FIG. 13, when the transmission axis 28A of the complex polarizing plate 28 is at 90°, the brightness level in the frontward direction is the highest. Regions (regions R5) on the right and the left relative to the frontward direction have brightness levels slightly higher than brightness levels of surrounding regions. Such differences in brightness level are too small to be recognized by human eyes. Namely, when the transmission axis 28A of the complex polarizing plate 28 is at 90°, the light exiting from the testing device T is less likely include light rays that travel in directions angled to the frontward direction toward the light exiting surface (side lobe light) in the “3 o'clock-to-9 o'clock” direction.

As illustrated in FIG. 13, when the transmission axis 28A of the complex polarizing plate 28 is at 90°, the brightness level in the frontward direction is the highest and brightness levels do not become unnecessary high in regions on the right and the left relative to the frontward direction. The side lobe light is actively reflected by the light elective reflection sheet 27 of the complex polarizing plate 28 and the polarization is canceled when reflected light rays are multiply scattered. The reflected light rays form a light flux that contributes to improvement of the brightness in the frontward direction. Therefore, the brightness levels do not become unnecessary high.

When the transmission axis 28A of the complex polarizing plate 28 is at 0°, the regions (the regions R4 and R5) on the right and the left relative to the frontward direction have the brightness levels higher than the brightness levels of the surrounding regions as illustrated in FIG. 14. The regions look brighter than the surrounding regions, that is, the differences in brightness level can be recognized by human eyes. When the transmission axis 28A of the complex polarizing plate 28 is at 0°, the light exiting from the testing device T includes light rays travel in directions angled to the frontward direction toward the light exiting surface (side lobe light) in the “3 o'clock-to-9 o'clock” direction. In a condition illustrated in FIG. 14, the brightness level in the forward direction is the highest.

Next, the brightness distribution (the light distribution characteristics) of the light exiting from the testing device T was measured with the optical goniometer (EZContrast by ELDIM) while the angle of the transmission axis 28A of the complex polarizing plate 28 was altered. Specifically, the brightness distribution (the light distribution characteristics) of the light exiting surface in the testing device T in the “12 o'clock-to-6 o'clock” direction and the brightness distribution (the light distribution characteristics) of the light exiting surface in the testing device T in the “3 o'clock-to-9 o'clock” direction were measured while the angle of the transmission axis 28A of the complex polarizing plate 28 was altered from 0° to 30°, 60°, 90°, 120°, and 150° in this sequence.

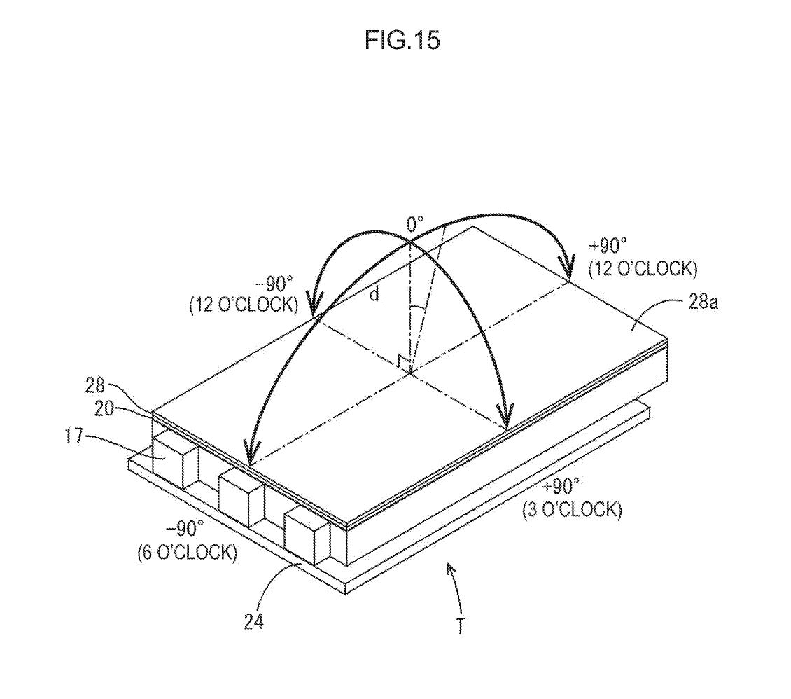

FIG. 15 is a perspective view schematically illustrating a relationship between the testing device T and another coordinate system. In FIG. 15, an observation angle (a polar angle) d is an angle relative to an imaginary line that passes the center of the light exiting surface 28a (the front surface of the complex polarizing plate 28) in the testing device T and perpendicular to the light exiting surface 28a. In the “12 o'clock-to-6 o'clock” direction, the LED 17 side is defined as −90° and the opposite side is defined as +90°. In the “3 o'clock-to-9 o'clock” direction, the right side viewed from the LED 17 side is defined as +90° and the opposite side is defined as −90°.

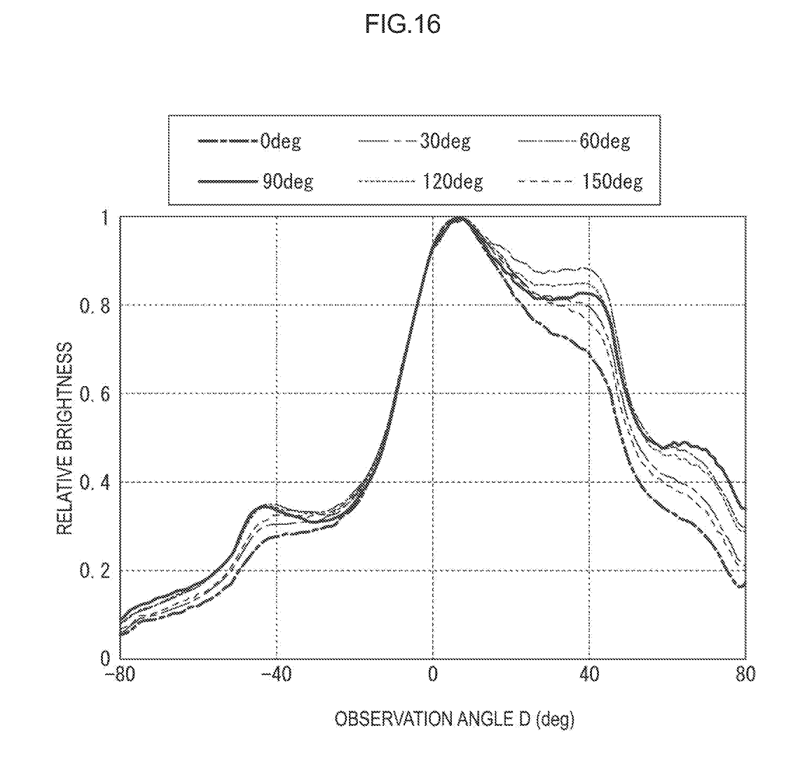

FIG. 16 illustrates the measured brightness distribution (the light distribution characteristics) in the “12 o'clock-to-6 o'clock” direction in the testing device T. In FIG. 16, the horizontal axis represents the observation angle d (deg.) in the 12 o'clock-to-6 o'clock” direction and the vertical axis represents the brightness (relative brightness) of the light exiting from the light exiting surface 28a in the 12 o'clock-to-6 o'clock” direction.

As illustrated in FIG. 16, the brightness (the relative brightness) in the 12 o'clock-to-6 o'clock” direction barely changed even though the angle of the transmission axis 28A of the complex polarizing plate 28 was altered.

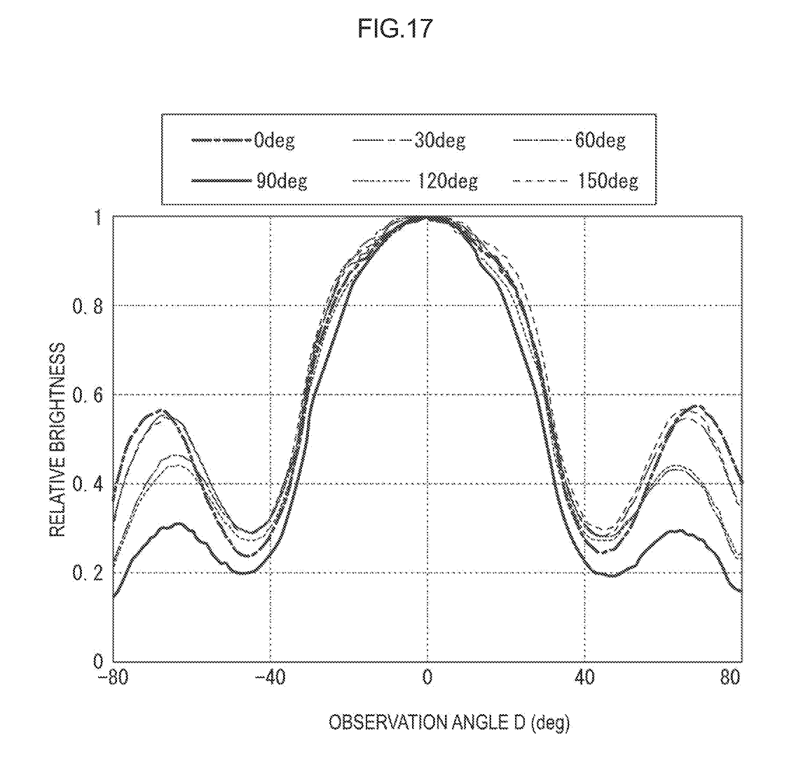

FIG. 17 illustrates the measured brightness distribution (the light distribution characteristics) in the 3 o'clock-to-9 o'clock” direction. In FIG. 17, the horizontal axis represents the observation angle d (deg.) in the 3 o'clock-to-9 o'clock” direction and the vertical axis represents the brightness (relative brightness) of the light exiting from the light exiting surface 28a in the 3 o'clock-to-9 o'clock” direction.

As illustrated in FIG. 17, in the brightness distribution (the light distribution characteristics) in the 3 o'clock-to-9 o'clock” direction, the brightness was locally increased in regions around d=about 60° to 70° and d=about −70° to −60° away from the frontward direction. The light was directed to such regions. As illustrated in FIG. 17, when the transmission axis 28A of the complex polarizing plate 28 was at 90°, the brightness (the relative brightness) in the regions around d=about 60° to 70° and d=about −70° to −60° was significantly reduced in comparison to other regions.

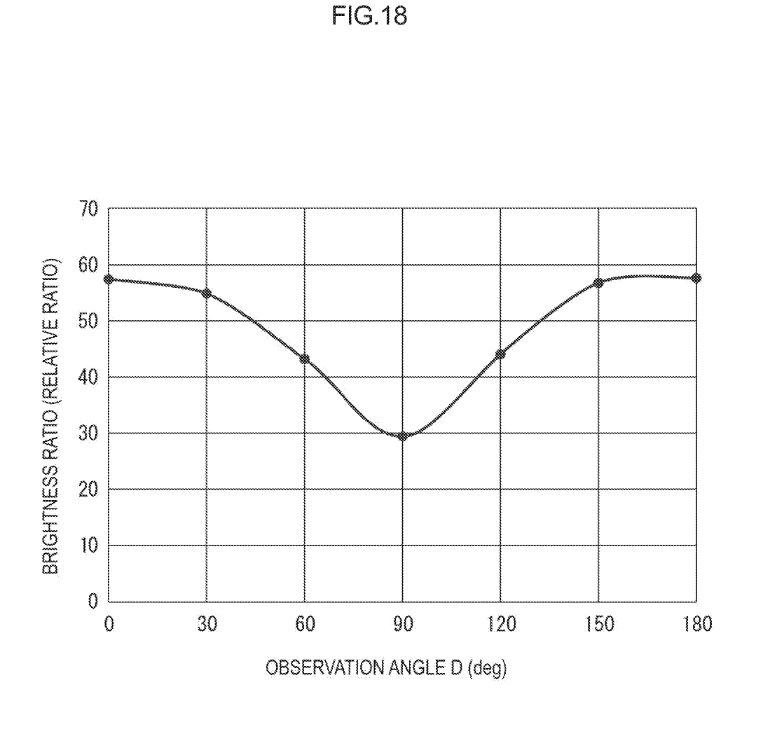

Next, relationships between brightness ratios (side lobe light/frontward light) and the angles of the transmission axis 28A of the complex polarizing plate 28 will be described with reference to FIG. 18 based on the frontward light (d=−45° to +450) and the side lobe light (other than the frontward light) extracted from the brightness distribution (the light distribution characteristics) in the 3 o'clock-to-9 o'clock” direction illustrated in FIG. 17. FIG. 18 is a graph illustrating a relationship between brightness ratio of the frontward light relative to the side lobe light in the 3 o'clock-to-9 o'clock” direction in the testing device and angle of the transmission axis 28A of the complex polarizing plate 28.

In FIG. 18, the horizontal axis represents the angle (deg.) of the transmission axis 28A of the complex polarizing plate 28 and the vertical axis represents the brightness ratio between the frontward light and the side lobe light (=side lobe light/frontward light). The brightness ratio is a relative ratio. As illustrated in FIG. 18, in the brightness distribution (the light distribution characteristics) in the 3 o'clock-to-9 o'clock” direction, when the transmission axis 28A of the complex polarizing plate 28 was at 90° (deg.), the brightness ratio was the smallest (i.e., the ratio of the side lobe light relative to the frontward light was the smallest).

As described above, in the liquid crystal display device 10 according to this embodiment, the transmission axis 28A of the complex polarizing plate 28 disposed on the rear side of the liquid crystal display panel 11 corresponds with the X-axis direction. Namely, the linearly polarized light having the vibration plane (the polarization direction) parallel to the X-axis direction among the light exiting from the backlight unit 12 transmits through the complex polarizing plate 28 and the linearly polarized light having the vibration plane (the polarization direction) parallel to the reflection axis 28B of the complex polarizing plate 28 is reflected by the polarization selective reflection sheet 27 of the complex polarizing plate 28.

By setting the transmission axis 28A of the complex polarizing plate 28 as above, the light rays exiting from the display surface DS of the liquid crystal display panel 11 and travel in the directions angled to the frontward direction toward the sides (the side lobe light) are reduced. Therefore, the uneven brightness in the light exiting from the display surface DS of the liquid crystal display panel 11 is less likely to occur.

By setting the transmission axis 28A of the complex polarizing plate 28 disposed on the rear side of the liquid crystal display panel 11 corresponding with the X-axis direction, the reduction in frontward brightness is less likely to occur.

Even through the touchscreen 14 and the cover panel 15 are disposed to cover the display surface DS of the liquid crystal display panel 11, the uneven brightness is less likely to occur in the light exiting from the display surface DS as described above. Therefore, the reduction in frontward brightness is less likely to occur.

### Second Embodiment

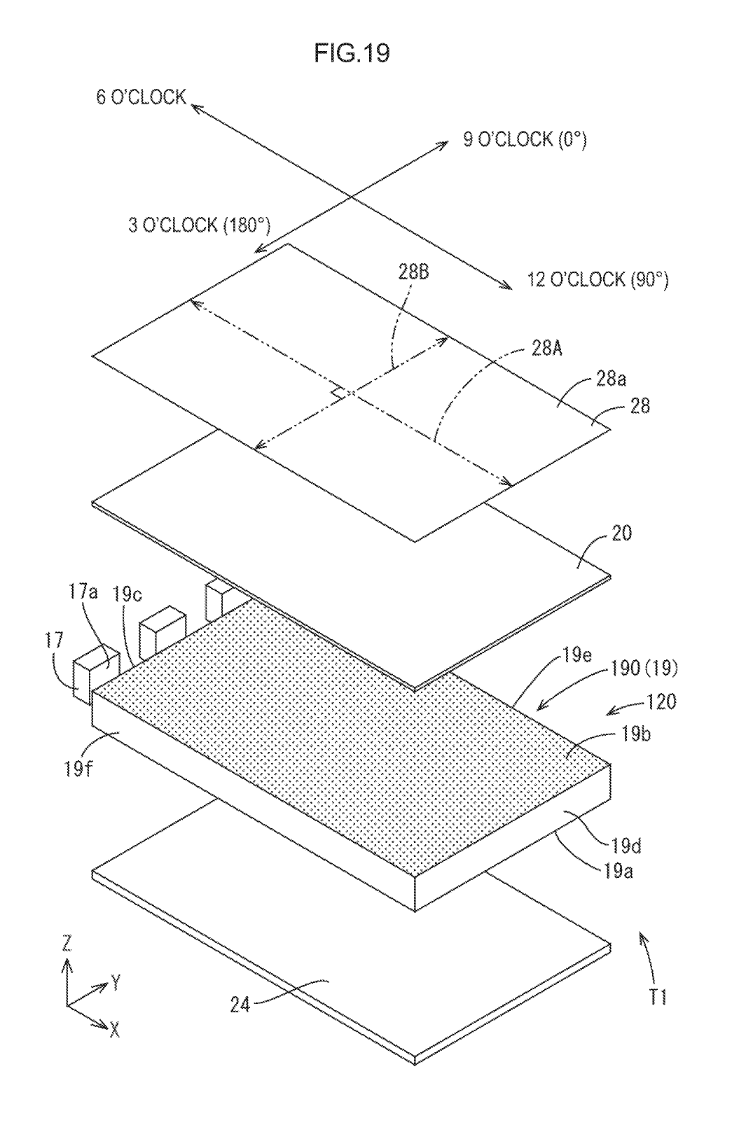

A second embodiment will be described with reference to FIG. 19. Structures similar to those of the first embodiment will be indicated by the same symbols and will not be described in detail hereinafter.

FIG. 19 is an exploded perspective view schematically illustrating a positional relationship between a backlight unit 120 and the complex polarizing plate 28 in a testing device T1 corresponding to a liquid crystal display device according to the second embodiment of the present invention. The testing device T1 in this embodiment includes a light guide plate 190, which is a difference from the testing device T in the first embodiment. Specifically, the light guide plate 190 in the testing device T1 in this embodiment includes a front surface and a rear surface that correspond to the rear surface and the front surface of the light guide plate 19 in the first embodiment, respectively. Other configurations are basically similar to those of the first embodiment.

Although the backlight unit 120 includes the light guide plate 190 that includes the front surface and the rear surface that correspond to the rear surface and the front surface of the light guide plate 19, respectively, the backlight unit 120 has a light collecting function similar to the first embodiment with respect to the Y-axis direction. Light rays that have entered the light guide plate 190 (the light guide plate 19) through the light entering surface 19c exit the light guide plate 190 through the rear surface (corresponding to the light exiting surface 19a of the light guide plate 19) toward the reflection sheet 24. The exiting light rays are most likely to be totally reflected by the reflection sheet 24 without cancellation of the polarization. The reflected light rays are repeatedly reflected inside the light guide plate 190 and exit the light guide plate 190 through the front surface (corresponding to the rear surface 19b of the light guide plate 19) toward the optical sheet 20.

In the backlight unit 120 having such a configuration, the number of reflection inside the light guide plate 190 is larger than that of the first embodiment. Therefore, further evenly spreading planar exiting light is achieved. Such a backlight unit 120 has a characteristic that fine foreign substances or forming irregularity is less recognizable even if the fine foreign substances enter the backlight unit 120 or the forming irregularity (e.g., burrs) occurs in production of the backlight unit 120. In such a backlight unit 120, the exiting light rays are collected with respect to the Y-axis direction with optical effects of the optical sheet 20 and the light guide plate 190 to direct the light rays in the frontward direction.

In such a backlight unit 120, when the transmission axis 28A of the complex polarizing plate 28 is orientated to correspond with the 12 o'clock-to-6 o'clock” direction (the X-axis direction, the optical axis direction of the LED 17), the light rays exiting from the light exiting surface 28a in the testing device T1 traveling in directions angled to the frontward direction toward the sides (side lobe light) are reduced. Therefore, the uneven brightness in light exiting from the light exiting surface 28a is less likely to occur.

### Third Embodiment

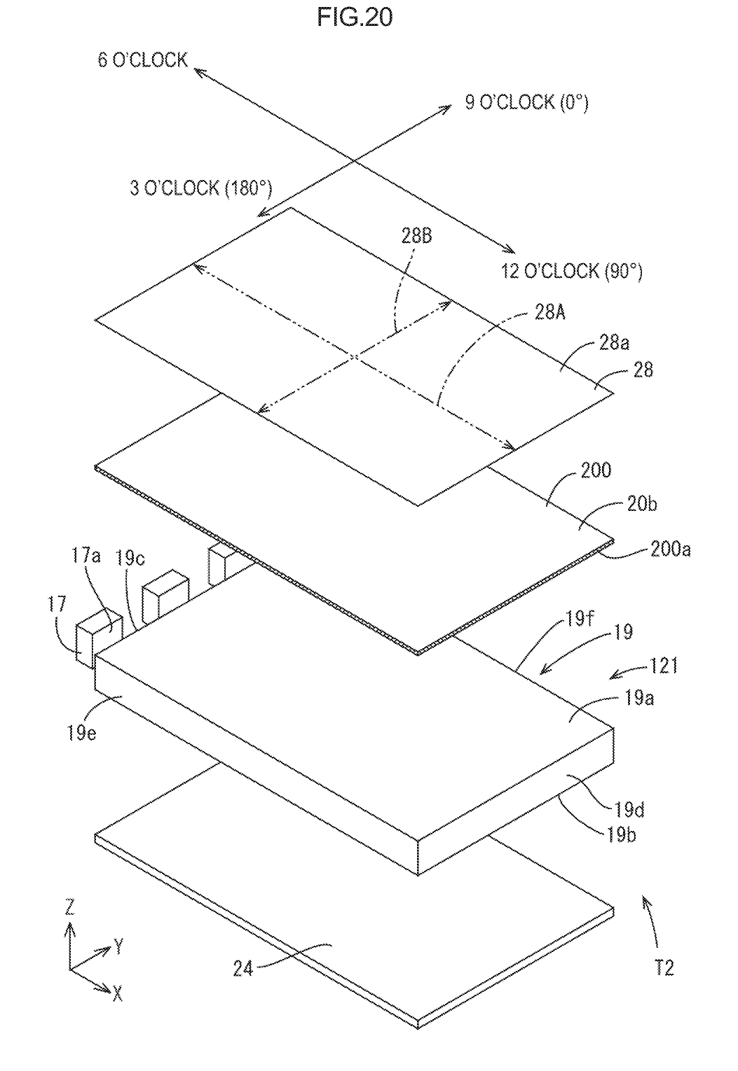

A third embodiment according to the present invention will be described with reference to FIG. 20. FIG. 20 is an exploded perspective view schematically illustrating a positional relationship between a backlight unit 121 and the complex polarizing plate 28 in a testing device T2 corresponding to a liquid crystal display device according to the third embodiment of the present invention.

The testing device T2 according to this embodiment includes an optical sheet 200, which is only difference between the testing device T2 and the testing device T according to the first embodiment. Specifically, the optical sheet 200 in the testing device T2 includes a sheet base 200b replaced with the sheet base 20a of the optical sheet 12 made of PET in the first embodiment. The sheet base 200b is made of material that does not have a birefringent property (e.g., polycarbonate, acrylic resin). Other configurations are basically similar to those of the first embodiment.

With such an optical sheet 200, when the transmission axis 28A of the complex polarizing plate 28 is at 90°, the frontward brightness level of light exiting from the testing device T2 is the highest. Furthermore, the frontward brightness levels change symmetrically about the transmission axis 28A at 90° more precisely than the first embodiment (see FIG. 11).

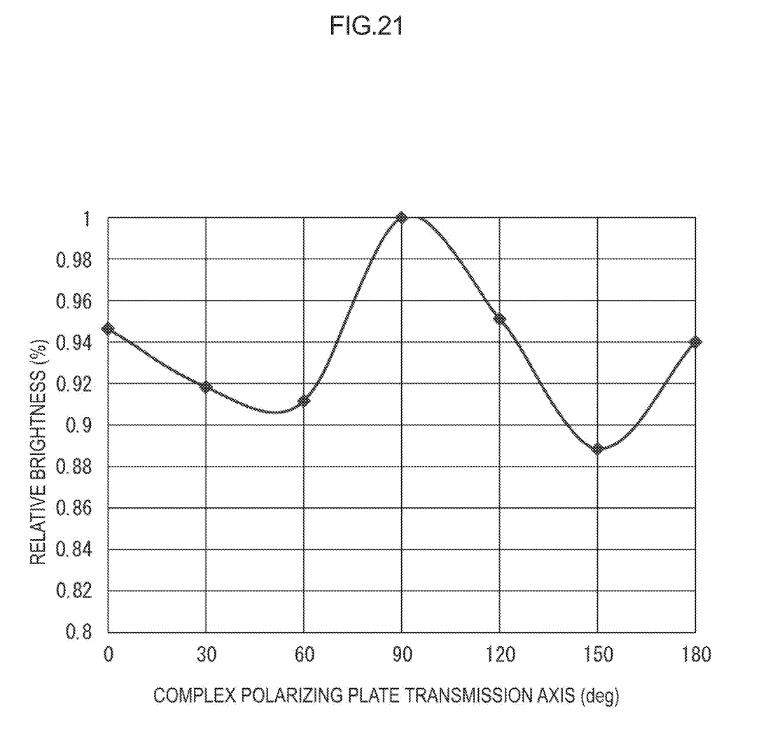

A relationship between an angle of a transmission axis of a complex polarizing plate in a testing device according to a comparative example and a brightness level in the frontward direction (a frontward brightness level) will be described with reference FIG. 21. FIG. 21 is a graph illustrating the relationship between angle of the transmission axis of the complex polarizing plate and relative value of the frontward brightness in the testing device according to the comparative example. The testing device according to the comparative example includes an optical sheet that includes a sheet base made of PET having a birefringent property. Configurations of the optical sheet other than the sheet base are similar to the first embodiment. The frontward brightness level of light exiting from the testing device according to the comparative example was the highest when the transmission axis of the complex polarizing plate was at 90°. The frontward brightness levels of the exiting light change asymmetrically about the transmission axis 28A at 90°.

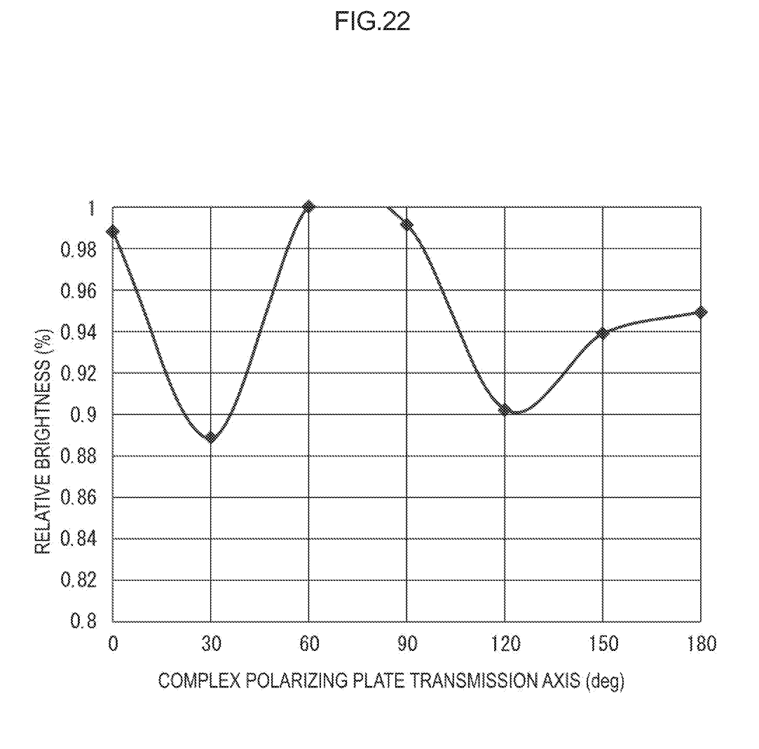

A relationship between angle of a transmission axis of a complex polarizing plate in a testing device according to another comparative example and brightness level in the frontward direction (frontward brightness level) will be described with reference to FIG. 22. FIG. 22 is a graph illustrating the relationship between angle of the transmission axis of the complex polarizing plate in the testing device according to the comparative example and relative value of the frontward brightness. The testing device according to the other comparative example includes a sheet base made of PET having a birefringent property. Configurations other than the sheet base are similar to the first embodiment. The frontward brightness level of light exiting from the testing device according to the other comparative example was not the highest when the transmission axis of the complex polarizing plate was at 90° as illustrated in FIG. 22. The brightness level was the maximum when the transmission axis was at about 70°. The frontward brightness levels of the exiting light changed asymmetrically about the transmission axis at 90°.

As illustrated in FIGS. 21 and 22, with the sheet base of the optical sheet having the birefringent property, the brightness level of the exiting light is not the maximum when the transmission axis of the complex polarizing plate is at 90°. Furthermore, the frontward brightness levels of the exiting light do not change symmetrically about the transmission axis at 90°. In general, the sheet base made of PET is less likely to have the birefringent property as in the first embodiment. However, the sheet base made of PET may have the birefringent property due to a different producing method or a portion of an original sheet of taken for the sheet base. Therefore, it is preferable to use a material that is less likely to have the birefringent property for the material for the sheet base of the optical sheet.

### Other Embodiment

The present invention is not limited to the above embodiments described with reference to the drawings. The following embodiments may be included in the technical scope of the present invention.

(1) In each of the above embodiments, the light guide plate 19 includes the front surface and the rear surface that include the light collecting portions (the front prism portion 43, the rear prism portion 44), respectively. However, the present invention is not limited to such a configuration. For example, only the front surface of the light guide plate 19 may include a light collecting portion such as the front prism portion 43 or only the rear surface of the light guide plate 19 may include a light collecting portion such as the rear prism portion 44.

(2) In each of the above embodiments, each of the unit light collecting portions (the front unit prisms 43a, the rear unit prisms 44a) of the light collecting portions of the front surface and the rear surface of the light guide plate 19 has the triangular cross section when viewed along the optical axis L. However, the present invention is not limited to such a configuration. The cross-sectional shape is not limited to a particular shape as long as the unit light collecting portions have the light collecting properties to collect the light rays with respect to the direction perpendicular to the optical axis L (the light collecting direction) to direct the light rays to travel in directions closer to the frontward direction and supply light to the optical sheet 20 so that the optical sheet 20 can exert the designed light collecting effects. For example, the cross-sectional shape may be a substantially semi-circular shape including a semicircular shape and a semi-elliptical shape.

(3) In each of the above embodiments, the optical sheet 20 includes the prism portion 20b that includes the unit prisms 20b1 each having the triangular cross section when viewed along the optical axis L. However, the optical sheet 20 may include cylindrical lenses that extend along the optical axis L and have substantially semicircular cross sections instead of the unit prisms 20b1. The shapes and the sizes of the prism portion 20b and the light collecting portions of the optical sheet such as the cylindrical lenses are not limited to any shapes and sizes as long as the light rays exiting from the optical sheet gather with respect to the direction perpendicular to the optical axis L (the light collecting direction) to direct the light rays in the frontward direction.

(4) In each of the above embodiments, the light from the light source enters the light guide plate 19 through one end surface (the light entering surface 19c). In each of the other embodiments, the opposite end surface 19d opposite from the light entering surface 19c may be configured as another light entering surface.

(5) In each of the above embodiments, the LEDs are used as the light source. However, other types of light sources such as organic ELs may be used in the other embodiments.

(6) In each of the above embodiments, the transmission axis of the polarizing plate 26 on the light entering side and the transmission axis of the polarizing plate 25 on the light exiting side are perpendicular to each other (a crossed Nichol configuration). However, the present invention is not limited to such a configuration. The transmission axis of the polarizing plate 25 on the light exiting side may be orientated as appropriate (e.g., parallel Nicole) according a liquid crystal mode.

(7) In each of the above embodiments, the optical sheet 20 includes a single prism sheet. However, another type of optical sheets (e.g., a diffuser sheet, a prism sheet) may be includes in the other embodiments as long as the effects of the present invention can be achieved.

### EXPLANATION OF SYMBOLS

10: Liquid crystal display device
11: Liquid crystal display panel
12: Backlight unit
13: Frame
14: Touchscreen
15: Cover panel
17: LED (light source, point light source)
19: Light guide plate
19a: Light exiting surface
19b: Rear surface
19c: Light entering surface
19d: Opposite end surface
20: Optical sheet (prism sheet)
20a: Sheet base
20b: Prism portion
20b1: Unit prism
24: Reflecting sheet
28: Complex polarizing plate
28A: Transmission axis
28B: Reflection axis
43: Front prism portion (light collecting portion)
43a: Front unit prism
44: Rear prism portion (light collecting portion)
44a: Rear unit prism
L: Optical axis

1. A liquid crystal display device comprising:
a light source;
a light guide plate that is a plate shaped member comprising a light entering surface, a light exiting surface, and a light collecting portion, wherein
the light entering surface is an end surface of the plate shaped member and opposed to the light source,
the light exiting surface is a front plate surface of the plate shaped member through which light entering through the light entering surface exits, and
the light collecting portion formed in the light exiting surface and/or a rear plate surface of the plate shaped member and configured to collect light rays exiting from the light exiting surface with respect to a light collecting direction perpendicular to an optical axis of the light source to direct the light rays in a frontward direction;
a backlight unit comprising an optical sheet disposed to cover the light exiting surface and collecting the light rays exiting through the light exiting surface with respect to the light collecting direction to direct the light rays in the frontward direction while transmitting the light rays therethrough; and
a complex polarizing plate comprising:
a selective reflection sheet including a first transmission axis for passing linearly polarized light in a first condition along the first transmission axis and a reflection axis perpendicular to the first transmission axis for reflecting linearly polarized light in a second condition along the reflection axis; and
a polarizing plate including a second transmission axis for passing the linearly polarized light in the first condition and being laid on the selective reflection sheet with the second transmission axis parallel to the first transmission axis, wherein
the complex polarizing plate is laid on the backlight unit with the first transmission axis and the second transmission axis along a non-light collecting direction perpendicular to the light collecting direction.

2. The liquid crystal display device according to claim 1, wherein the optical sheet comprises a sheet base having a sheet shape and a prism sheet including a prism portion formed on a front surface of the sheet base opposed to the complex polarizing plate, wherein
the prism portion includes a plurality of unit prisms having elongated shapes that extend in the non-light collecting direction, and
the unit prisms are arranged along the non-light collecting direction.

3. The liquid crystal display device according to claim 2, wherein each of the unit prisms has a triangular cross section with a vertex having an angle of 90°.

4. The liquid crystal display device according to claim 2, wherein the sheet base is made of material that does not have a birefringent property.

5. The liquid crystal display device according to claim 1, wherein the light collecting portion comprises a plurality of unit light collecting portions having elongated shapes that extend along the non-light collecting direction and being arranged along the light collecting direction.

6. The liquid crystal display device according to claim 5, wherein each of the unit light collecting portions has a triangular cross section with a vertex having an obtuse angle or a semicircular cross section.

7. The liquid crystal display device according to claim 1, wherein the light source comprises a plurality of point light sources arranged in line along the light collecting direction.

8. The liquid crystal display device according to claim 1, wherein the backlight unit includes the light guide plate that is the plate shaped member disposed in a flipped position.

9. The liquid crystal display device according to claim 1, further comprising:
a light exiting-side polarizing plate opposed to the complex polarizing plate; and
a liquid crystal display panel disposed between the complex polarizing plate and the light exiting-side polarizing plate.
